(19) United States
(12) Patent Application Publication
(10) Pub. No.: US 2026/0003875 A1
(43) Pub. Date: Jan. 1, 2026

(54) CHANGE MANAGEMENT AND CLOUD STORAGE FOR UNIFIED DATA CATALOG

(71) Applicant: Wells Fargo Bank, N.A., San Francisco, CA (US)

(72) Inventors: Dae H. Lim, Charlotte, NC (US); Sachin M. Amritkar, Fort Mill, SC (US); Christopher T. Walsh, Rock Hill, SC (US); Aldo G. Figallo, Concord, NC (US); Kee Heng Chan, Arcadia, CA (US); Barry Smith, Waxhaw, NC (US)

(21) Appl. No.: 19/249,485

(22) Filed: Jun. 25, 2025

Related U.S. Application Data
(60) Provisional application No. 63/664,555, filed on Jun. 26, 2024.

(51) Int. Cl. G06F 16/2457; G06F 16/23

(52) U.S. Cl. CPC G06F 16/24573; G06F 16/2358

(57) ABSTRACT

A computing system is described that includes a memory storing a plurality of information assets and a processing system of an enterprise, the processing system comprising one or more processors implemented in circuitry. The processing system is configured to receive a query for metadata for an information asset stored in one or more data catalogs of the enterprise. The processing system determines a location of the metadata using a metadata registry that stores mapping data that maps information assets to locations of metadata for the information assets, the locations corresponding to the data catalogs of the enterprise. The processing system retrieves the metadata from the determined location and provides the metadata in response to the query.

This application claims the benefit of U.S. Provisional Application No. 63/664,555, filed 26 Jun. 2024, the entire contents of which is incorporated herein by reference.

### TECHNICAL FIELD

The disclosure relates to computer-based systems for managing data, and, more specifically, managing metadata.

### BACKGROUND

A number of technology platforms exist that provide users or businesses the ability to collect and store large amounts of data. Such a platform may exist to provide users or businesses the ability to gain business insights on data. However, for many businesses, such as a bank, operational risks and security threats that can arise with data mismanagement must be minimized to maintain good industry standards and regulations that pertain to data collection and use. For example, Global Systemically Important Banks (G-SIB) are crucial players in the global financial system, but their size and complexity make them potential sources of systemic risk. Therefore, to avoid financial crises and promote the stability of the financial system, G-SIB banks are subject to strict data regulation requirements. These regulations mandate that G-SIB banks report, monitor, and analyze vast amounts of data relating to their risk exposures, capital adequacy, liquidity, and systemic importance.

To safeguard sensitive data, G-SIB banks must comply with data protection laws and regulations. The fulfillment of these data regulation requirements is critical for G-SIB banks to maintain the confidence of their stakeholders, regulators, and the wider financial system. Thus, G-SIB banks and many other businesses may find it advantageous to impose stricter, more robust, and more automated data management practices or systems.

### SUMMARY

In general, this disclosure describes a computing system including a unified data catalog for managing data. The data catalog may utilize platform and vendor agnostic APIs to collect metadata from data platforms (including technical metadata, business metadata, data quality, and lineage, etc.), collect data use cases (including regulatory use cases, risk use cases, or operational use cases deployed on one or more data reporting platforms, data analytics platforms, data modeling platforms, etc.), and collect data governance policies or procedures and assessment outcomes (including one or more of data risks, data controls, or data issues retrieved from risk systems, etc.) from risk platforms. The data catalog may then define data domains aligned to a particular reporting structure, such as that used to report financial details in accordance with requirements established by the Security and Exchange Commission, or according to other enterprise-established guidelines. The data catalog may further build data insights, reporting, scorecards, and metrics for transparency on the status of data assets and corrective actions.

In particular, this disclosure is directed to techniques related to managing metadata for information assets of a unified data catalog or other data catalogs, which may be in various physical or network locations. For example, an enterprise may store data assets in each of a variety of data catalogs that may have different locations, such as on premises, in a public cloud, and/or in a private cloud. This disclosure describes techniques for managing metadata for information stored across various disparate data catalogs, to ensure that the metadata is up to date and easily accessible, and such that underlying information assets described by the metadata and the metadata itself can be accessed from the correct location.

In one example, this disclosure is directed towards a computing system comprising: a memory storing a plurality of information assets; and a processing system of an enterprise, the processing system comprising one or more processors implemented in circuitry, the processing system being configured to: receive a query for metadata for an information asset stored in one or more data catalogs of the enterprise; determine a location of the metadata using a metadata registry that stores mapping data that maps information assets to locations of metadata for the information assets, the locations corresponding to the data catalogs of the enterprise; retrieve the metadata from the determined location; and provide the metadata in response to the query.

In another example, this disclosure is directed towards a computer-implemented method comprising: receiving, by one or more processors, a query for metadata for an information asset stored in one or more data catalogs of the enterprise; determining, by the one or more processors, a location of the metadata using a metadata registry that stores mapping data that maps information assets to locations of metadata for the information assets, the locations corresponding to the data catalogs of the enterprise; retrieving, by the one or more processors, the metadata from the determined location; and providing, by the one or more processors, the metadata in response to the query.

In a further example, this disclosure is directed towards non-transitory computer-readable storage media having stored thereon instructions that, when executed, cause one or more processors to: receive a query for metadata for an information asset stored in one or more data catalogs of the enterprise; determine a location of the metadata using a metadata registry that stores mapping data that maps information assets to locations of metadata for the information assets, the locations corresponding to the data catalogs of the enterprise; retrieve the metadata from the determined location; provide the metadata in response to the query; maintain the metadata registry, wherein each of the data catalogs stores a respective subset of information assets; determine that an information asset of one of the data catalogs has been modified; and update the metadata registry in response to the modification.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system configured to generate a data model comprising one or more data sources, one or more data use cases, and one or more data governance policies retrieved from one or more of a plurality of data platforms via one or more of a plurality of platform and vendor agnostic APIs, in accordance with one or more techniques of this disclosure.

FIG. 2 is a block diagram illustrating an example system including vendor and platform agnostic APIs configured to ingest data, in accordance with one or more techniques of this disclosure.

FIG. 3 is a conceptual diagram illustrating an example system configured to generate, based on the level of quality of a data source, a report indicating the status of the data domain and data use case, in accordance with one or more techniques of this disclosure.

FIG. 4 is a block diagram illustrating an example system configured to generate a unified data catalog, in accordance with one or more techniques of this disclosure.

FIG. 5 is a flowchart illustrating an example process by which a computing system may generate a data model comprising one or more data sources, one or more data use cases, and one or more data governance policies retrieved from one or more of a plurality of data platforms via one or more of a plurality of platform and vendor agnostic APIs, in accordance with one or more techniques of this disclosure.

FIG. 6 is a block diagram illustrating an example computing system that may be configured to perform the techniques of this disclosure.

FIG. 7 is a flow diagram illustrating an example flow between elements of the evaluation unit of FIG. 6 that may be performed to calculate an overall health score for one or more information assets of FIG. 6.

FIG. 8 is a conceptual diagram illustrating a graphical representation of completion status and progress metrics that may be generated by the evaluation unit of FIG. 6.

FIG. 9 is a block diagram illustrating an example automated data management framework (ADMF) according to techniques of this disclosure.

FIGS. 10 and 11 are example user interfaces that may be used to navigate a dashboard view presented to interact with the information assets of FIG. 6.

FIG. 12 is an example reporting user interface that may be used to present and receive interactions with curated reports on various devices, such as mobile devices.

FIG. 13 is a conceptual diagram illustrating an example graphical depiction of a road to compliance report representing compliance with data management policies.

FIG. 14 is a conceptual diagram illustrating an example graphical user interface that may be presented by personal assistant unit via a user interface.

FIG. 15 is a block diagram illustrating an example set of components of the business metadata generation unit of FIG. 6.

FIG. 16 is a block diagram illustrating an example data management system 300 according to techniques of this disclosure.

FIG. 17 is a flow diagram illustrating example operations of receiving and responding to a query for metadata for an information asset, according to techniques of this disclosure.

### DETAILED DESCRIPTION

This disclosure describes various techniques related to management of and interaction with business enterprise data. A computing system performing the techniques of this disclosure may create a seamless view of the state of enterprise data to provide transparency at the executive management level to ensure appropriate use of the data, and to allow for taking corrective actions if needed. This disclosure also describes techniques by which the computing system may present a visual representation of the enterprise data, e.g., in diagram and/or narrative formats, regarding enterprise information assets, such as critical and/or augmented information and metrics.

The computing system may be configured to collect information assets, including, for example, data sources, use cases, source documents, risks, controls, data quality defects, compliance plans, health scores, human resources, workflows, and/or outcomes. The computing system may identify and maintain multiple dimension configurations of the information assets, e.g., regarding content, navigation, interaction, and/or presentation. The computing system may ensure that the information value of the content is timely, relevant, pre-vetted, and conforms to a user request. The computing system may ensure that the user can efficiently find a targeted function, and that the user understands a current use context and how to traverse the system to reach a desired use context. The computing system may ensure that the user can interact with data (e.g., information assets) effectively. The computing system may further present data to the user in a manner that is readily comprehensible by the user.

The computing system may support various operable configurations, such as private configurations, protected configurations, and public configurations. Users with proper access privileges may interact with the computing system in a private configuration as constructed by such users. Other users with proper access privileges may interact with the computing system in a protected configuration, which may be restricted to a certain set of users. Users with public access privileges may be restricted to interact with the computing system only in a public configuration, which may be available to all users.

The computing system may provide functionality and interfaces for augmentation and integration with additional services, such as artificial intelligence/machine learning (AI/ML). The computing system may also identify, merge, and format information assets into various standard user interfaces (UIs) and report package templates for reuse.

In this manner, the computing system may enable users to make informed decisions for a variety of scenarios, whether simple or complex, from different perspectives. For example, users may start and end anywhere within a fully integrated information landscape. The computing system may provide a representation of an information asset to a user, receive a query from the user about one or more information assets, and traverse data related to the information asset(s) to discover applicable content. The computing system may also enable users to easily find, maintain, and track movement, compliance, and approval status of data, external or internal to their data jurisdictions across supply chains. Information assets may be configurable, such that the user can view historical, real-time, and predicted future scenarios.

The computing system may be configured to generate a comprehensive data model that includes one or more data sources, one or more data use cases, and one or more data governance policies. In some examples, the one or more data sources, one or more data use cases, and one or more data governance policies are retrieved from one or more of a plurality of data platforms via one or more platform and vendor agnostic application programming interfaces (APIs). The computing system may be designed in such a way that these APIs are aligned to one or more data domains, wherein one of the one or more platform and vendor agnostic APIs exists for each subject area of the data model (e.g., tech metadata, business metadata, data sources, use cases, data controls, data defects, etc.).

In some examples, the computing system uses identifying information from the one or more data sources to create a data linkage between one of the data sources, one of the data use cases, one of the data governance policies, and one of the data domains. The data linkage may be enforced by the platform and vendor agnostic API, which ensures that the data sources are properly linked to their respective data use cases and data governance policies. Additionally, the data use case may be monitored and controlled by a data use case owner, and the data domain may be monitored and controlled by a data domain executive. This may ensure that the data is used correctly and that the data governance policies are followed.

The computing system may use data governance policy and quality criteria set forth by the data use case owner and the data domain executive to determine the level of quality of a data source and ensure that the data being used is of high quality and suitable for its intended use case. Finally, based on the level of quality of the data source, the computing system may generate a report indicating the status of the data domain and data use case associated with that data source. This report may be used to evaluate the overall quality of the data and identify any issues that need to be addressed.

The computing system described herein may provide a comprehensive approach to managing data by consolidating and aligning data sources, data use cases, data governance policies, and APIs to specific data domains within a business. The computing system may also provide a way to link data sources to their respective data use cases and data governance policies, as well as a way to monitor and control the use of data by data use case owners and data domain executives. Additionally, the computing system may ensure the quality of data by evaluating data sources against set quality criteria and providing a report on the status of data domains and data use cases.

The vendor and platform agnostic APIs may be configured to ingest data, which may include a plurality of data structure formats. In some examples, the one or more data use cases include one or more of a regulatory use case, a risk use case, or an operational use case deployed on one or more of a data reporting platform, a data analytics platform, or a data modeling platform. In some examples, the computing system grants access to the data use case owner to the data controls for one or more of the one or more data sources, wherein the one or more data sources are mapped to the data use case that is monitored and controlled by the data use case owner. In some examples, the computing system receives data indicating that the data use case owner has verified the data controls for the one or more data sources.

In some examples, the one or more data governance policies include one or more of data risks, data controls, or data issues retrieved from risk systems. In some examples, the data domains are defined in accordance with enterprise-established guidelines. Each data domain may include a sub-domain. In some examples, creating the data linkage includes identifying, based on one or more data attributes, each of the one or more data sources; determining the necessary data controls for each of the one or more data sources; and mapping each of the one or more data sources to one or more of the one or more data use cases, the one or more data governance policies, or the one or more data domains. In some examples, the generated report indicates one or more of the number of data sources determined to have the necessary level of quality, the number of data sources approved by the data domain executive, or the number of use cases using data sources approved by the data domain executive.

This disclosure recognizes that many enterprise organizations have multiple data platforms, such as on-premises platforms, public cloud platforms, private cloud platforms, or the like. Thus, such organizations typically rely on multiple data catalog tools to collect metadata from each of the various platforms into a single data catalog solution. However, this may result in creation of multiple copies of the metadata, as well as lag and inconsistencies in the metadata. Users of a data management system of an enterprise organization may expect to have access to the latest metadata for the organization, regardless of the location/platform on which that metadata is stored or origin point for the metadata, and that the metadata is accurate, complete, and timely. Additionally, such users may expect to be able to act timely to comply with enterprise data management and governance policies, to make appropriate business decisions based on insights offered by the metadata or underlying data.

This disclosure describes techniques that may provide a consistent user experience with a unified data catalog or other data management system, regardless of how many data catalog tools or solutions are used. These techniques may provide access to the latest, accurate, consistent, and integrated metadata, regardless of origin or location in a single enterprise-wide tool. In this manner, users may view required metadata for data management and governance and exclude unwanted metadata.

The data management system of this disclosure, per these techniques, may provide a quick response time to user queries or other data interactions, regardless of quality, volume, or location of metadata. These techniques may be used to avoid creation of multiple copies of metadata. These techniques may also be used to batch data interaction jobs to improve timeliness, quality, and consistency. The data management system of this disclosure may track change management and provide notifications of changes to downstream stakeholders. The data management system may further provide change notifications to various users, which may optimize operations and improve overall efficiency. The data management system may map applications within an enterprise, connections between the applications and downstream applications and use cases, to allow for tracing between such applications as changes are made. Thus, the data management system may offer low cost data maintenance and operation solutions. References to “metadata” may include technical metadata, business metadata, linkage data, quality check data, and/or metric data.

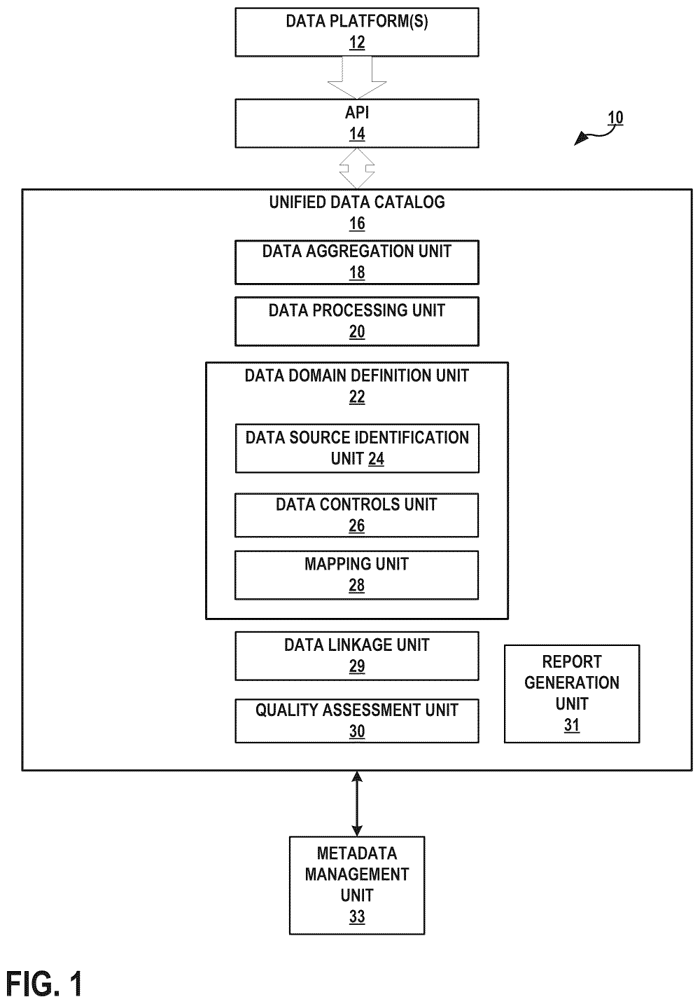

FIG. 1 is a conceptual diagram illustrating an example system configured to generate a data model comprising data sources, data use cases, and data governance policies retrieved from one or more of a plurality of data platforms via one or more of a plurality of platform and vendor agnostic application programming interfaces (APIs), in accordance with one or more techniques of this disclosure. In the example of FIG. 1, system 10 is configured to generate unified data catalog (UDC) 16. Unified data catalog 16 is configured to retrieve one or more data sources, one or more data use cases, and one or more data governance policies from one or more of a plurality of data platforms 12 via one or more of a plurality of platform and vendor agnostic APIs 14. Data platforms 12 may represent on premises platforms, public cloud platforms, private cloud platforms, or any other such platforms from which data may be retrieved for an enterprise.

Unified data catalog 16 further includes data aggregation unit 18. In some examples, data aggregation unit 18 collects, integrates, and consolidates data from one or more data platforms 12 via APIs 14 into a single, unified format or view. In some examples, data aggregation unit 18 retrieves data from data platforms 12 using various data extraction methods, such as SQL queries, web scraping, and file parsing.

As discussed in greater detail below, unified data catalog 16 or components that interact with unified data catalog 16 may be configured to calculate overall data quality for one or more information assets stored in unified data catalog 16. Such data quality values may be, for example, overall health scores as discussed in greater detail below. Unified data catalog 16 may provide business metadata curation and recommend data element names and business metadata. Unified data catalog 16 may enable lines of business to build their own metadata and lineage via application programming interfaces (APIs).

Unified data catalog 16 may provide or act as part of an automated data management framework (ADMF). The ADMF may implement an integrated capability to provide representative sample data and a shopping cart to allow users to access needed data directly. The ADMF may allow users to navigate textually and/or visually (e.g., node to node) across a fully integrated data landscape. The ADMF may provide executive reporting on personal devices and applications executed on mobile devices. The ADMF may also provide for social collaboration and interaction, e.g., to allow users to define data scoring. The ADMF may show data lineage in pictures, linear upstream/downstream dependencies, and provide the ability to see data lineage relationships.

Unified data catalog 16 may provide consistent data domains across data platforms. Users (e.g., administrators) may create consistent data domains across data platforms (e.g., Teradata and Apache Hadoop). Unified data catalog 16 may proactively establish data domains in a cloud platform, such as Google Cloud Platform (GCP) or cloud computing using Amazon Web Services (AWS), before data is moved to the cloud platform. Unified data catalog 16 may align data sets to data domains before the data sets are moved to the cloud platform. Unified data catalog 16 may further provide technical details on how to use the data domains in the cloud platform, aligned to the data domain concept implemented in unified data catalog 16.

Unified data catalog 16 may provide a personal assistant to users to aid various personas, e.g., a domain executive, BDL, analyst, or the like, to execute their daily tasks. Unified data catalog 16 may provide a personalized list of tasks to be completed in a user's inbox, based on progress to date based on the user's persona and progress made to date. Unified data catalog 16 may provide a clear status on percent completion of various tasks. Unified data catalog 16 may also provide the user with the ability to set goals, e.g., a target domain quality score goal for a current year for an approved data source, and may track progress toward the goals.

Unified data catalog 16 may showcase cost, efficiency, and defect hotspots using a dot cloud visualization. Unified data catalog 16 may also quantify data risks of the hotspots. Unified data catalog 16 may further generate new business metadata attributes and descriptions. For example, unified data catalog 16 may leverage generative artificial intelligence capabilities to generate such business metadata attributes and descriptions.

Unified data catalog 16 further includes data processing unit 20. In some examples, data processing unit 20 is configured to filter and sort data that has been aggregated by data aggregation unit 18. Data processing unit 20 may also clean, validate, normalize, and/or transform data such that it is consistent, accurate, and understandable. For example, data processing unit 20 may perform a quality check on the consolidated data by applying validation rules and data quality metrics to ensure that the data is accurate and complete. In some examples, data processing unit 20 may output the consolidated data in a format that can be easily consumed by other downstream systems, such as a data warehouse, a business intelligence tool, or a machine learning model. Data processing unit 20 may also be configured to maintain the data governance policies and procedures set forth by an enterprise for data lineage, data security, data privacy, and data audit trails. In some examples, data processing unit 20 is responsible for identifying and handling any errors that occur during the data collection, integration, and consolidation process. For example, data processing unit 20 may log errors, alert administrators, and/or implement error recovery procedures. Data processing unit 20 may also ensure optimal performance of the system by monitoring system resource usage and implementing performance optimization techniques such as data caching, indexing, and/or partitioning.

In some examples, existing data management sources, use cases, and controls may be integrated into unified data catalog 16 to prevent disruption of any existing processes. In some examples, ongoing maintenance for data management sources, used cases, and controls may be provided for unified data catalog 16. In some examples, data quality checks and approval mechanisms may be provided for ensuring that data loaded into unified data catalog 16 is accurate. In some examples, unified data catalog 16 may utilize machine learning capabilities to rationalize data. In some examples, unified data catalog 16 may use a manual process to rationalize data. In some examples, unified data catalog 16 may implement a server-based portal for confirmation/approval workflows to confirm data.

Unified data catalog 16 further includes data domain definition unit 22 that includes data source identification unit 24, data controls unit 26, and mapping unit 28. Data source identification unit 24 may be configured to identify one or more data platforms 12 associated with data that has been aggregated by data aggregation unit 18 and processed by data processing unit 20. For example, data source identification unit 24 may identify a data platform or source associated with a portion of data by scanning for specific file types or by searching for specific keywords within a file or database. Data source identification unit 24 may identify the key characteristics and attributes of the data. Data source identification unit 24 may further be used to ensure data governance and compliance by identifying and classifying sensitive or confidential data. In some examples, data source identification unit 24 may be used to identify and remove duplicate data as well as to generate metadata about the identified data platforms or sources, such as the data's creator, creation date, and/or last modification date.

Data controls unit 26 may be configured to identify the specific security and privacy controls that are required to protect data. Data controls unit 26 may also be configured to determine the specific area or subject matter that the controls are related to. For example, if a data source contains sensitive personal information such as credit card numbers, social security numbers, or medical records, the data would be considered sensitive data and would be subject to regulatory compliance such as HIPAA, PCI-DSS, or GDPR. In some examples, data controls unit 26 may identify specific security controls such as access control, encryption, and data loss prevention that are required to protect the data from unauthorized access, disclosure, alteration, or destruction. Data controls unit 26 may generate metadata about the necessary data controls, such as the data control type. In some examples, data controls unit 26 may further ensure that the data outputted by data processing unit 20 meets a certain quality threshold. For example, if the specific subject matter determined by data controls unit 26 is social security numbers, data controls unit 26 may check if any non-nine-digit numbers or duplicate numbers exist. Further processing or cleaning may be applied to the data responsive to data controls unit 26 determining that the data does not meet a certain quality threshold.

In some examples, all data sources are documented by unified data catalog 16, and all data quality controls are built around data source domains. In some examples, data controls unit 26 may determine that the right controls do not exist, which may result in an open control issue. For example, responsive to data controls unit 26 determining that the right controls do not exist, an action plan aligned to the control issue may be executed by a data use case owner to resolve the control issue. In some examples, data controls may be built around data use cases and/or data sources, in which the data use case owner may verify that the correct controls are in place. In some examples, the data use case owner is granted access to the data controls for the one or more data sources that are mapped to the data use case that is monitored and controlled by the data use case owner. Responsive to the data use case owner verifying the data controls for the one or more data sources, the computing system may receive data indicating that the data use case owner has verified the data controls. In some examples, a machine learning model may be implemented by data controls unit 26 to determine whether the correct controls exist, enough controls exist, and/or whether any controls are missing.

Mapping unit 28 may be configured to map data to a specific data domain based on information identified by data source identification unit 24 and data controls unit 26. For example, if data source identification unit 24 and data controls unit 26 determine that a portion of data is sourced from patient medical records and is assigned to regulatory compliance such as HIPAA, mapping unit 28 may determine the data domain to be healthcare. In some examples, mapping unit 28 may assign a code or identifier to the data that is then used to create automatic data linkages between data sources, data use cases, data governance policies, and data domains pertaining to the data. In some examples, mapping unit 28 may generate other data elements or attributes that are used to create data linkages. In some examples, a machine learning model may be implemented by mapping unit 28 to determine the data domain for each data source.

Taken together, data domain definition unit 22 may define a data domain specifying an area of knowledge or subject matter that a portion of data relates to. Once the data domain is defined by data domain definition unit 22, the data domain can be used to guide decisions for data governance, data management, and data security. The data domain may also be used to ensure that the data is used in compliance with regulatory requirements and to help identify any potential regulatory or compliance issues related to the data within that data domain. Additionally, the data domain may help to identify any additional data controls that may be needed to protect the data. In some examples, the data domains may be pre-defined. For example, a business may define data domains that are aligned to the Wall Street reporting structure and the operating committee level executive management structure to prior to tying all metadata, use cases, and risk assessments to their respective data domains. In some examples, multiple data domains may exist, in which each domain includes identified data sources, written controls, mapped appropriate use cases, a list of uses cases with associated controls/accountability, and a report that provides the status of the domain (e.g., how many and/or which use cases are using approved data sources).

In some examples, data domain definition unit 22 may also identify specific sub-domains within a larger data domain. For example, within a finance domain, there may be sub-domains such as investments, banking, and accounting. For example, within a healthcare domain, there may be sub-domains such as cardiovascular health, mental health, and pediatrics.

Information assets, also referred to herein as data assets, may be aligned to one or more data domains and sub-domains to simplify implementation of domain-specific data management policy requirements, banking product and platform architecture (BPPA), data products, data distribution, use of the data, entitlements, and cost reduction. Data domain definition unit 22 may create domains and sub-domains in accordance with enterprise-established guidelines. Data domain definition unit 22 may assign data sources and data use cases to domain, sub-domain, and data products, with business justification and approval. Data domain definition unit 22 may align technical metadata and business metadata with data sources or data use cases, agnostic to data platform. Data domain definition unit 22 may communicate domain, sub-domain, data products, and associations to data platforms via vender- and platform-agnostic APIs, such as API 14. Data domain definition unit 22 may automatically create a data mesh to implement BPPA and data products using API 14 on data platforms, regardless of whether the platform is on premises, private cloud, hybrid cloud, or public cloud.

Data domain definition unit 22 may define data domains, sub-domains, and data products in accordance with enterprise-established guidelines. Data source identification unit 24 and mapping unit 28 may align information assets to the defined data domains, sub-domains, and data products. Data controls unit 26 may define controls for the information assets and alignment. Data domain definition unit 22 may leverage API 14 to communicate with data platform 12 to automatically create a data mesh, controls, and entitlements.

Unified data catalog 16 further includes data linkage unit 29 that may be configured to create a data linkage between one of the data sources, one of the data use cases, one of the data governance policies, and one of the data domains. Unified data catalog 16 may unify multiple components together, i.e., unified data catalog 16 may establish linkages between various components that used to be scattered. More specifically, data linkage unit 29 may connect data from various sources by identifying relationships between data sets or elements. In some examples, data linkage unit 29 may identify relationships between data sources, data use cases, data governance policies, and data domains based on identifying information included in the data or metadata. For example, data source identification unit 24 may identify the key attributes of the data and data controls unit 26 may identify the correct data controls based on the key attributes of the data. Mapping unit 28 may then be used to generate data attributes or elements that indicate a specific data domain based on the information identified by data source identification unit 24 and data controls unit 26. Data linkage unit 29 may then automatically create data linkages between data sources, data use cases, data governance policies, and data domains based on the data domain that mapping unit 28 has aligned the data to. In some examples, data linkage unit 29 may improve data quality by also identifying and rectifying errors or inconsistencies in the data that prevent linkages from being created.

By creating these automatic data linkages, unified data catalog 16 may provide a more efficient and organized means of ingesting large amounts of data. For example, 5000 data sources belonging to 7 different domains may be ingested into unified data catalog 16, in which the linkages between all the data sources and all the data domains are created automatically by data linkage unit 29. Further, the automatic data linkages created by data linkage unit 29 may provide a more comprehensive understanding of the data and its context. For example, linking data from various sources such as customer purchase history, customer demographic data, and customer online activity can provide a deeper understanding of customer behavior and preferences.

In some examples, the data linkages created by data linkage unit 29 are enforced by platform and vendor agnostic APIs 14. For example, a single API may be constructed for each data domain that has built-in hooks for direct connection into a repository of data sources associated with a particular data domain. In some examples, the APIs may be designed to enable the exchanging of data in a standardized format. For example, the APIs may support REST (Representational State Transfer), which is a widely-used architectural style for building APIs that use HTTP (Hypertext Transfer Protocol) to exchange data between applications. REST APIs enable data to be exchanged in a standardized format, which may then enable data linkages to be created more easily and efficiently. In some examples, some data linkages may need to be manually created by a data use case owner who monitors and controls the data use case and/or by the data domain executive who monitors and controls the data domain.

Unified data catalog 16 further includes quality assessment unit 30 that may be configured to determine, based on the data governance policy and quality criteria set forth by the data use case owner and the data domain executive, the level of quality of the data source. In some examples, a machine learning model may be implemented by quality assessment unit 30 to determine a numerical score for each data source that indicates the level of quality of the data source. In some examples, data sources may also be sorted into risk tiers by quality assessment 30, wherein certain risk tiers indicate that a data source is approved and/or usable, which may be based on the numerical score exceeding a required threshold set forth by the data use case owner and/or the data domain executive. In some examples, the data use case owner and/or the data domain executive may be required to manually fix any data source that receives a numerical score less than the required threshold.

Unified data catalog 16 may output data relating to a data source to report generation unit 31. In some examples, report generation unit 31 may generate, based on the level of quality of the data source, a report indicating the status of the data domain and data use case. For example, in the case of a mortgage, a form (i.e., a source document) may be submitted to a loan officer. All data flows may start from the source document, wherein the source document is first entered into an origination system and later moved into an aggregation system (in which customer data may be brought in and aggregated with the source document). A report may need to be provided to regulators that states whether discrimination occurred during the flow of data. Well-defined criteria may need to be used to determine whether discrimination occurred, such as criteria for data quality (based on, for example, entry mistakes, data translation mistakes, data loss, ambiguous data, negative interest rates). Further, publishing and marketing of data may have different data quality criteria. As such, data controls may need to be implemented to ensure proper data use. In this example, report generation unit 31 may generate a report indicating the status of the mortgage domain, the publishing use case, and the marketing use case based on the quality of the source document.

Unified data catalog 16 may build data insights, reporting, scorecards, and metrics for transparency on the status of data assets and corrective actions to provide executive level accountability for data quality, data risks, data controls, and data issues. In some examples, unified data catalog 16 may include a domain “scoreboard” or dashboard that provides an on-demand report of data stored within unified data catalog 16. For example, the domain dashboard may show each data source with its associated policy designation, domain, sub-domain, and app business owner. Unified data catalog 16 may further classify each data use case, data source, and data control. The domain dashboard may further define and inventory data domains.

In this way, unified data catalog 16 may provide users and/or businesses an insightful and organized view of data that may aid in making business decisions. Additionally, the reporting capabilities of unified data catalog 16 may aid in simplifying data flows, as the insights provided by unified data catalog 16 may identify which data sources are of low quality or have little value add to a certain process.

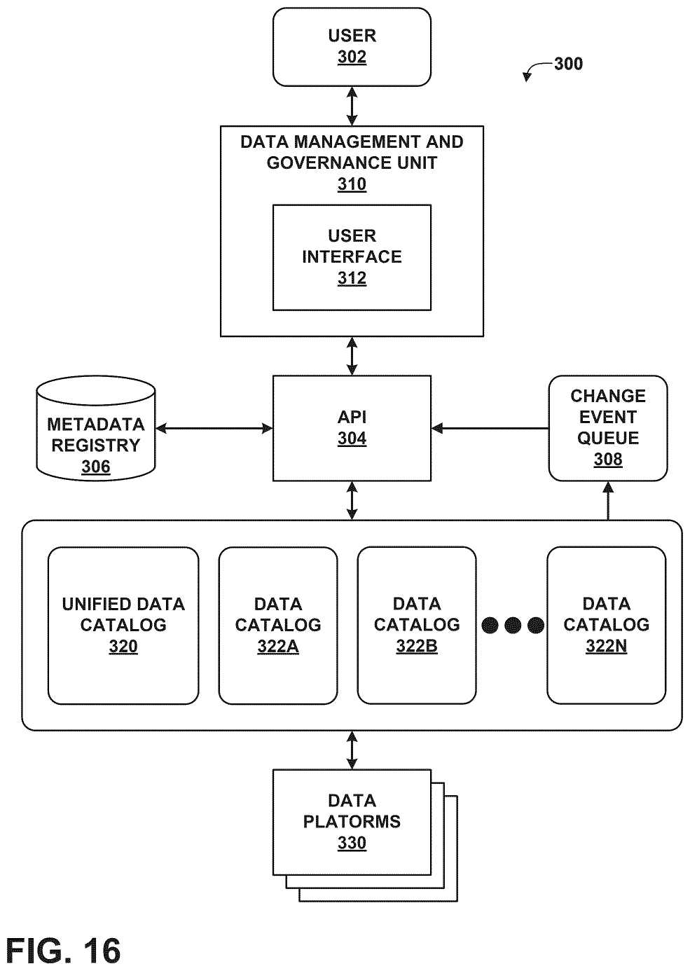

Per the techniques of this disclosure, system 10 also includes metadata management unit 33. Metadata management unit 33 may be configured to provide an enterprise user access to metadata representative of various information assets of unified data catalog 16. A user may use metadata management unit 33 to gain access to recent metadata of system 10, regardless of a location or origin of the metadata. This allows the user to act timely to comply with enterprise data management and governance policies, and to gain insights into the metadata to make appropriate business decisions for the enterprise organization. In general, metadata management unit 33 may include a user interface, a data management and governance unit, an API to interact with unified data catalog 16, a metadata registry, and a change event queue, e.g., as shown in FIG. 16, discussed in greater detail below.

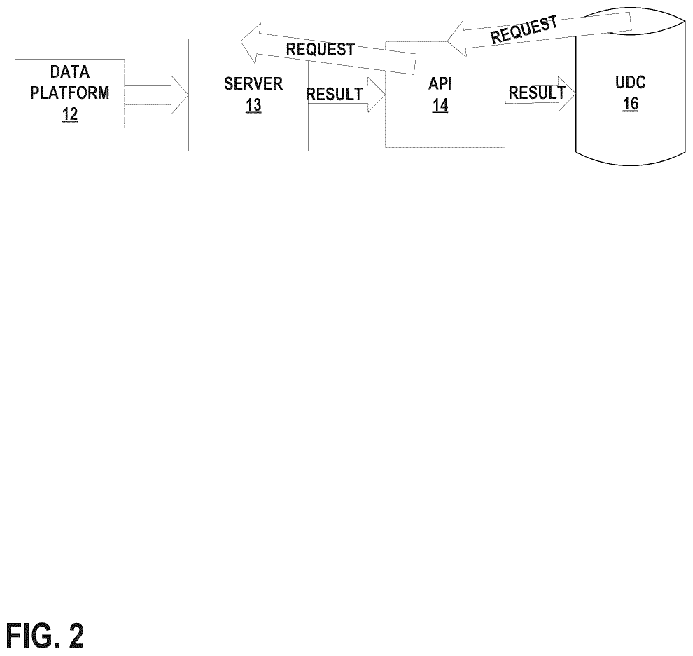

FIG. 2 is a block diagram illustrating an example system including vendor and platform agnostic APIs configured to ingest data, in accordance with one or more techniques of this disclosure. One API may exist per data domain or subject matter (e.g., the same API may be used for a bulk upload or manual entry of data). In the example of FIG. 2, unified data catalog 16 establishes a connection to data platform 12 via platform and vendor agnostic APIs 14 and server 13. APIs 14, in accordance with the techniques described herein, may be APIs that are not tied to a specific platform or vendor, i.e., APIs 14 may be designed to function across multiple different platforms and technologies, regardless of the vendor used. For example, APIs 14 may be designed to function across different types of hardware and software platforms, such as Windows, Linux, or MacOS, or any other type of platform that supports the API. APIs 14 may further be designed to function across different vendors' products, i.e., APIs 14 are not specific to a particular vendor and can be used to connect to different products from different vendors. Thus, APIs 14 may provide a consistent and standardized way of accessing data across different data platforms 12, regardless of the vendor or technology used. APIs 14 may be used to bring all data into a rationalized and structured data model to link data sources, application owners, and domain executives. APIs 14 may allow unified data catalog 16 to connect to different data platforms 12 which may be, but are not limited to, databases, data warehouses, data lakes, and cloud storage systems, in a consistent and uniform manner. APIs 14 may collect metadata, data use cases, and/or data governance policies or procedures and assessment outcomes from data platforms 12. Data platforms 12 may be any reporting, analytical, modeling, or risk platforms.

In the example of FIG. 2, a request may be sent by a client, such as a user or an application of unified data catalog 16, to server 13. The request may be a simple query, a command to retrieve data, or a request for access to a specific data platform 12. API 14 may receive the request from unified data catalog 16 first before translating the request and sending it to server 13. Upon receiving the request from API 14, server 13 may process the request and may access data platform 12 to retrieve the requested data. Server 13 may then send data back to the API 14, which may format the data into a standardized format that unified data catalog 16 can understand or ingest. API 14 may then send the data to unified data catalog 16, wherein unified data catalog 16 may then store the received data.

APIs 14 may be further configured to support authentication and authorization procedures, which may help ensure that data is accessed and used in accordance with governance policies and regulations. For example, APIs 14 may define and enforce rules for data access and usage that ensure only authorized users are able to access certain data and that all data is stored and processed in compliance with regulatory requirements.

In some examples, an automated data management framework may be implemented to perform automatic metadata harvesting while utilizing the same API. In some examples, external tools may be used to pull in data. In some examples, unified data catalog 16 may include different data domains with preestablished links that are enforced via APIs 14. For example, a technical metadata API may create an automatic data linkage for all technical metadata pertaining to the same data domain. The automated data management framework may further automate the collection of metadata, data use cases, and risk assessment outcomes into unified data catalog 16. The automated data management framework may also automate a user interface to maintain and provide updates on the contents of unified data catalog 16. The automated data management framework may also provide a feature to automatically manage data domains defined in accordance with enterprise-established guidelines (e.g., the Wall Street reporting structure and the Wells Fargo operating committee level executive management structure). The automated data management framework may also automate approval workflows that align the contents of unified data catalog 16 to the different data domains. The automated data management framework may be applied to G-SIB banks, but may also be applied to any regulated industry (Financial Services, Healthcare, etc.).

Implementing data management and governance may use metadata for information assets and a lineage of the information assets. Lines of business may build their own metadata and lineage via APIs, such as API 14 as shown in FIG. 2. Such APIs may enable data platforms, authorized business users, and technology users to send new or changed technical metadata automatically or manually in UDC 16. API 14 may be a platform- and/or vendor-agnostic API. API 14 may enable data platforms, authorized business users, and technology users to send new and changed lineage data automatically or manually to UDC 16. API 14 may further enable data platforms, authorized business users, and technology users to send new and changed business metadata automatically or manually to UDC 16.

Data platforms, such as data platform 12, authorized business users, and technology users may invoke API 14 to send new and changed metadata and lineage data to UDC 16. API 14 may perform requestor authorization, validation, and/or desired processing, and may communicate back with requestor success or failure messages appropriately.

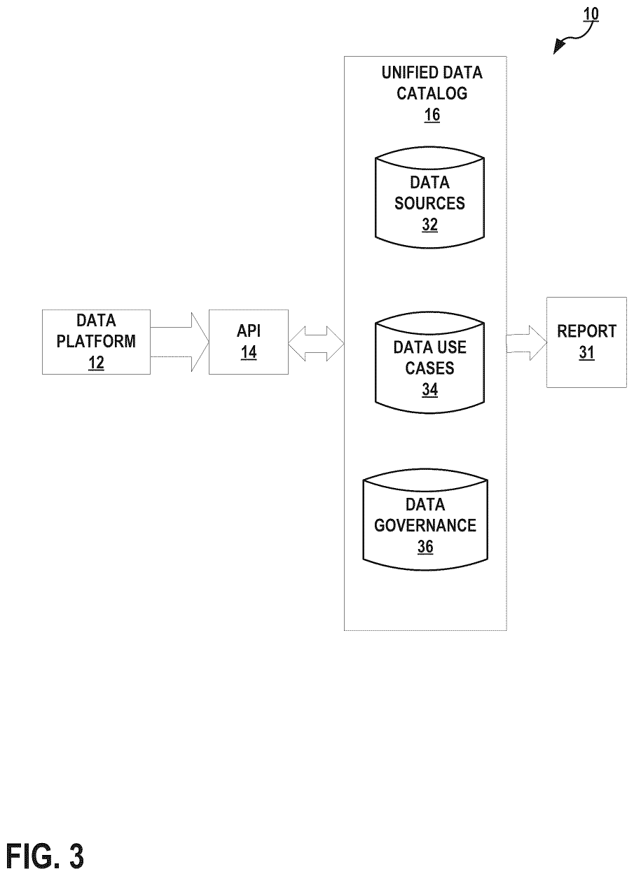

FIG. 3 is a conceptual diagram illustrating another view of example system 10 configured to generate, based on the level of quality of a data source, a report indicating the status of the data domain and data use case, in accordance with one or more techniques of this disclosure. In the example of FIG. 3, unified data catalog 16 includes data sources storage unit 32, data use cases storage unit 34, and data governance storage unit 36. System 10 of FIG. 1 may operate substantially similar to system 10 of FIG. 3, and both may include the same components. Data sources storage unit 32 may be configured to store and manage data sources within unified data catalog 16. Data sources storage unit 32 may serve as a central repository for data sources that are retrieved from data platforms 12 via APIs 14, allowing users to discover, understand, and access data from data platforms 12 without needing to know the specific technical details of each platform. Data sources storage unit 32 may be configured to store data sources in a variety of formats, such as structured, semi-structured, and unstructured data. Data sources storage unit 32 may also store data sources in different storage systems, such as relational databases, data lakes, or cloud storage. Data sources storage unit 32 may be configured to handle large amounts of data while meeting scalability and performance requirements. Data sources storage unit 32 may also provide a secure and controlled access to data sources by implementing access control mechanisms such as role-based access control, data masking, and encryption to protect the data from unauthorized access, disclosure, alteration, or destruction. Additionally, data sources storage unit 32 may provide a way to version the data sources, and track changes to the data over time. Data sources storage unit 32 may also support data lineage, or provide information about where the data came from, how it was processed, and how it was used.

In some examples, technical metadata may be pulled into unified data catalog 16 from a data store via APIs 14. The technical metadata may undergo data aggregation, data processing, data controls identification, data mapping, and data domain alignment as described with respect to FIG. 1. The technical metadata may include a group of data attributes, such the relationship with the data store. The technical metadata may also be stored in data sources storage unit 32. In another example, business metadata may also be pulled into unified data catalog 16 via APIs 14. The business metadata may define business data elements for physical data elements in the technical metadata. In other words, the business metadata may provide context about the data in terms of its meaning, usage, and relevance to the business while the technical metadata describes the physical data elements or technical aspects of the data, such as its format, type, lineage, and quality. The business metadata may also undergo data aggregation, data processing, data controls identification, data mapping, and data domain alignment as described with respect to FIG. 1. As such, unified data catalog 16 may consolidate and link business metadata utilized by business analysts and data scientists with technical metadata utilized by database administrators, data architects, or other IT professionals upon determining that the technical metadata and business metadata are aligned to the same data domain.

In some examples, upon sending a request to APIs 14 to pull in business metadata, an additional operation may be performed to check if a linked physical data element already exists. In some examples, upon sending a request to APIs 14 to pull in a physical data element, an additional operation may be performed to check if a dataset and data store already exists. In some examples, if a data linkage is not identified, an error message may be generated. In some examples, if certain metadata cannot be loaded, a flag may be set to reject the entire file containing the metadata.

Data use cases storage unit 34 of unified data catalog 16 may be configured to store data containing information pertaining to various data use cases within an organization. In some examples, data use cases storage unit 34 stores data including use case identification information (e.g., the name, description, and type of the use case). As such, data use cases storage unit 34 may allow for easy discovery, management, and governance of data use cases by providing a unified view of all relevant information pertaining to data usage. The data use case data may undergo data aggregation, data processing, data controls identification, data mapping, and data domain alignment as described with respect to FIG. 1. In some examples, users of unified data catalog 16 may search for specific use cases by name or browse by specific categories. In some examples, users of unified data catalog 16 may also submit new use cases for review and approval by data use case owners and/or domain executives.

Data governance storage unit 36 of unified data catalog 16 may be configured to store data containing information pertaining to the management and oversight of data within an organization. In some examples, data governance storage unit 36 may store data including information indicating data ownership, data lineage, data quality, data security, data policies, and assessed risk. Data governance storage unit 36 may allow for easy management and enforcement of data governance policies by providing a unified view of all relevant information pertaining to data governance. The data governance data may undergo data aggregation, data processing, data controls identification, data mapping, and data domain alignment as described with respect to FIG. 1. In some examples, user of unified data catalog 16 may submit new governance policies for review and approval by data use case owners and/or data domain executives. Additionally, data governance storage unit 36 may be configured to monitor compliance with governance policies within unified data catalog 16 and identify any potential violations. Data governance storage unit 36 may also store information relating to compliance and governance activities and provide an auditable trail of all changes made to any policies within unified data catalog 16.

Taken together, unified data catalog 16 may output information relating to a data source or platform to report generation unit 31 that is based on the data linkage created between the data source or platform and the data use cases, data governance policies, and data domains by unified data platform 16. For example, with respect to FIGS. 1 and 2, upon a portion of data being retrieved from data platform 12 via API 14, the portion of data may undergo data aggregation, data processing, data controls identification, data mapping, and data domain alignment. The portion of data may then undergo a data linkage in which the data is linked to other portions of data that are aligned to the same data domain and/or data use cases and data governance policies that are aligned to the same data domain. Each step may be performed in accordance with the information stored in data sources storage unit 32, data use cases storage unit 34, and data governance storage unit 36. The portion of data may further undergo a quality assessment. Upon determining the level of quality of the portion of data based on the information stored in data sources storage unit 32, data use cases storage unit 34, and data governance storage unit 36, report generation unit 31 may generate a report indicating the status of the data domain aligned to the portion of data and the data use case linked to the portion of data. The report may also indicate the quality and credibility of the data source or platform from which the portion of data was retrieved. As such, users of unified data catalog 16 may gain a better understanding of relationships between the data and which data are lacking in value, which ultimately may aid in gaining better understanding of the state of the data and better business insights.

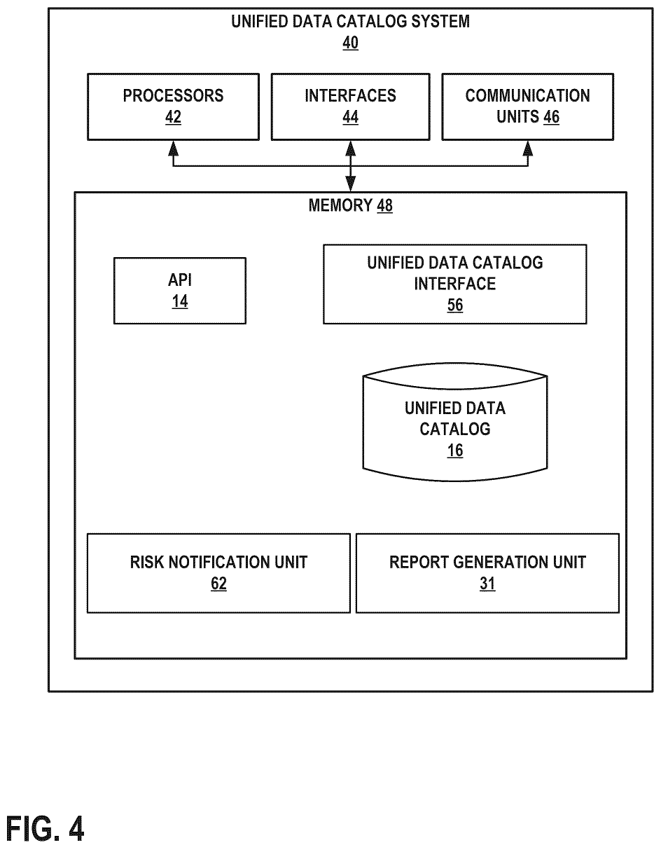

FIG. 4 is a block diagram illustrating an example system configured to generate a unified data catalog, in accordance with one or more techniques of this disclosure. In the example of FIG. 4, unified data catalog system 40 includes one or more processors 42, one or more interfaces 44, one or more communication units 46, and one or more memory units 48. Unified data catalog system 40 further includes API unit 14, unified data catalog interface unit 56, unified data catalog storage unit 16, risk notification unit 62, and report generation unit 31, each of which may be implemented as program instructions and/or data stored in memory 48 and executable by processors 42 or implemented as one or more hardware units or devices of unified data catalog system 40. Memory 48 of unified data catalog system 40 may also store an operating system (not shown) executable by processors 42 to control the operation of components of unified data catalog system 40. Although not shown in FIG. 4, the components, units, or modules of unified data catalog system 40 are coupled (physically, communicatively, and/or operatively) using communication channels for inter-component communications. In some examples, the communication channels may include a system bus, a network connection, an inter-process communication data structure, or any other method for communicating data.

Processors 42, in one example, may comprise one or more processors that are configured to implement functionality and/or process instructions for execution within unified data catalog system 40. For example, processors 42 may be capable of processing instructions stored by memory 48. Processors 42 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory 48 may be configured to store information within unified data catalog system 40 during operation. Memory 48 may include a computer-readable storage medium or computer-readable storage device. In some examples, memory 48 includes one or more of a short-term memory or a long-term memory. Memory 48 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 48 is used to store program instructions for execution by processors 42. Memory 48 may be used by software or applications running on unified data catalog system 40 to temporarily store information during program execution.

Unified data catalog system 40 may utilize communication units 46 to communicate with external devices via one or more networks. Communication units 46 may be network interfaces, such as Ethernet interfaces, optical transceivers, radio frequency (RF) transceivers, or any other type of devices that can send and receive information. Other examples of such network interfaces may include Wi-Fi, NFC, or Bluetooth® radios. In some examples, unified data catalog system 40 utilizes communication unit 46 to communicate with external data stores via one or more networks.

Unified data catalog system 40 may utilize interfaces 44 to communicate with external systems or user computing devices via one or more networks. The communication may be wired, wireless, or any combination thereof. Interfaces 44 may be network interfaces (such as Ethernet interfaces, optical transceivers, radio frequency (RF) transceivers, Wi-Fi or Bluetooth radios, or the like), telephony interfaces, or any other type of devices that can send and receive information. Interfaces 44 may also be output by unified data catalog system 40 and displayed on user computing devices. More specifically, interfaces 44 may be generated by unified data catalog interface 56 of unified data catalog system 40 and displayed on user computing devices. Interfaces 44 may include, for example, a GUI that allows users to access and interact with unified data catalog system 40, wherein interacting with unified data catalog system 40 may include actions such as requesting data, searching data, storing data, transforming data, analyzing data, visualizing data, and collaborating with other user computing devices.

Risk notification unit 62 may generate alerts or messages to administrators upon the detection of any risks within unified data catalog system 40. For example, upon data processing unit 20 logging a particular error, risk notification unit 62 may send a message to alert administrators of unified data catalog system 40. In another example, upon certain metadata not being able to be loaded into unified data catalog system 40, risk notification unit 62 may generate a message to administrators that indicates the entire file containing the metadata should be rejected.

Unified data catalog system 40 of FIG. 4 may provide a dot cloud representation of unified data catalog 16. The dot cloud may allow executives and decision makers to more easily make better business decisions within their scope (e.g., domain, sub-domain, or the like). Processors 42 may collect various data via interfaces 44, where the data may include, for example, costs, defects, efficiency, or the like. Processors 42 may integrate those various sets of data and present the data via interfaces 44 in a configurable manner. For example, processors 42 may render visual and/or textual representations of the data to allow users to interrogate or work with the data.

Processors 42 may collect additional needed data via interfaces 44. Processors 42 may communicate the additional data to unified data catalog 16 via API 14 to allow for interrogation and storage with existing data (e.g., existing information assets). Processors 42 may then present a representation of the data via interfaces 44 to a user. Processors 42 may also present multiple configuration options to allow the user to request a display of the information via interfaces 44 in a manner that is best suited to the user's needs.

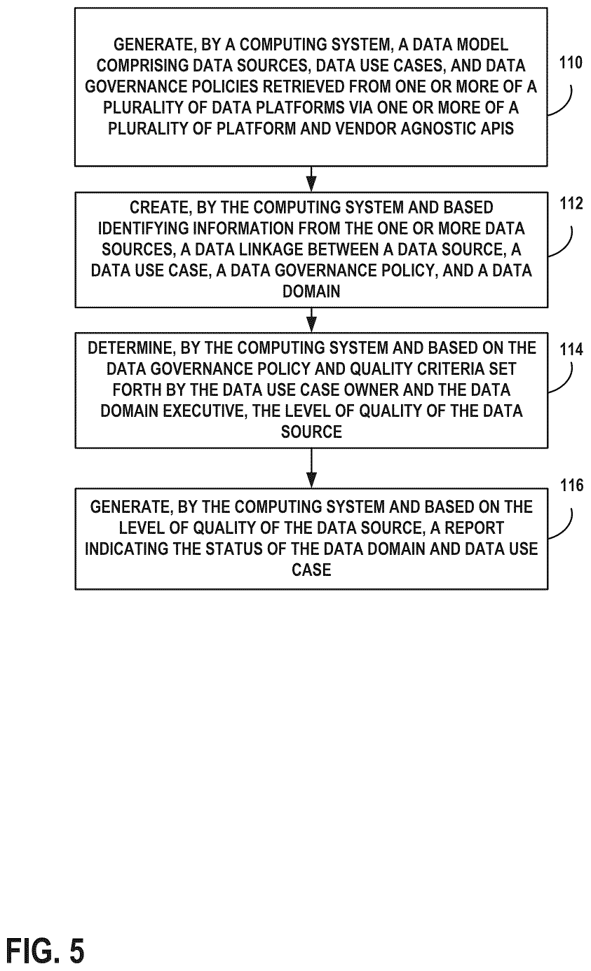

FIG. 5 is a flowchart illustrating an example process by which a computing system may generate a data model comprising data sources, data use cases, and data governance policies retrieved from one or more of a plurality of data platforms via one or more of a plurality of platform and vendor agnostic APIs, in accordance with one or more techniques of this disclosure. The technique of FIG. 5 may first include generating, by a computing system, a data model comprising data sources, data use cases, and data governance policies retrieved from one or more of a plurality of data platforms via one or more of a plurality of platform and vendor agnostic APIs (110). The data sources, data use cases, data governance policies, and APIs are aligned to one or more of a plurality of data domains. One vendor and platform agnostic API may exist for each data domain or subject area of the data model. The technique further includes creating, by the computing system and based identifying information from the one or more data sources, a data linkage between a data source, a data use case, a data governance policy, and a data domain (112). The data linkage is enforced by the platform and vendor agnostic API. The data use case is monitored and controlled by a data use case owner and the data domain is monitored and controlled by a data domain executive. The technique further includes determining, by the computing system and based on the data governance policy and quality criteria set forth by the data use case owner and the data domain executive, the level of quality of the data source (114). The technique further includes generating, by the computing system and based on the level of quality of the data source, a report indicating the status of the data domain and data use case (116).

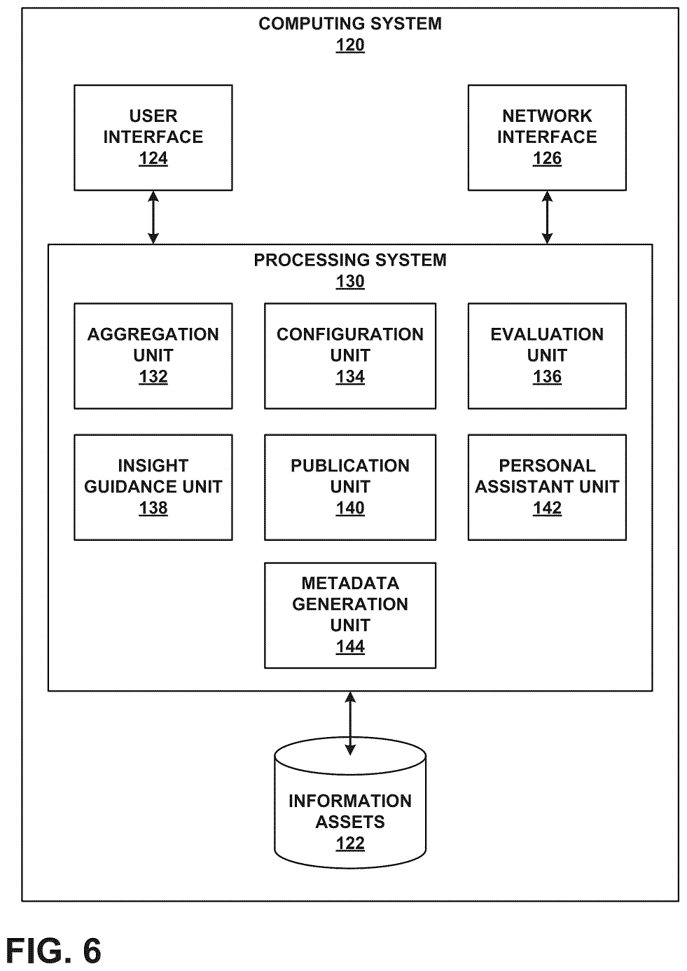

FIG. 6 is a block diagram illustrating an example computing system 120 that may be configured to perform the techniques of this disclosure. Computing system 120 includes components similar to those of system 10 of FIG. 1. Computing system 120 may perform techniques similar to those of system 10. In addition, computing system 120 may be configured to perform additional or alternative techniques of this disclosure.

In this example, computing system 120 includes user interface 124, network interface 126, information assets 122, and processing system 130. Processing system 130 further includes aggregation unit 132, configuration unit 134, evaluation unit 136, insight guidance unit 138, publication unit 140, personal assistant unit 142, and metadata generation unit 144. Information assets 122 may be stored in a unified data catalog, such as UDC 16 of FIGS. 1-4.

The various units of processing system 130 may be implemented in hardware, software, firmware, or a combination thereof. When implemented in software or firmware, requisite hardware (such as one or more processors implemented in circuitry) and media for storing instructions to be executed by the processors may also be provided. The processors may be, for example, any processing circuitry, alone or in any combination, such as one or more microprocessors, digital signal processors (DSPs), application specific integrated circuits (ASICs), field programmable gate arrays (FPGAs), or any other equivalent integrated or discrete logic circuitry, as well as any combinations of such components. Although shown as separate components, any or all of aggregation unit 132, configuration unit 134, evaluation unit 136, insight guidance unit 138, publication unit 140, personal assistant unit 142, and metadata generation unit 144 may be implemented in any one or more processing units, in any combination.

In general, information assets 122 may be stored in one or more computer-readable storage media devices, such as hard drives, solid state drives, or other memory devices, in any combination. Information assets 122 may include data representative of, for example, data sources, use cases, source documents, risks, controls, data quality defects, compliance plans, health scores, human resources, workflows, outcomes, or the like.

A user may interact with computing system 120 via user interface 124. User interface 124 may represent one or more input and/or output devices, such as video displays, touchscreen displays, keyboards, mice, buttons, printers, microphones, still image or video cameras, or the like. A user may query data of information assets 122 via user interface 124 and/or receive a representation of the data via user interface 124. In addition or in the alternative, a user may interact with computing system 120 remotely via network interface 126. Network interface 126 may represent, for example, an Ethernet interface, a wireless network interface such as a WiFi interface or Bluetooth interface, or a combination of such interfaces or similar devices. In this manner, a user may interact with computing system 120 remotely via a network, such as the Internet, a local area network (LAN), a wireless network, a virtual local area network (VLAN), a virtual private network (VPN), or the like.

The various components of processing system 130 as shown in FIG. 6, i.e., aggregation unit 132, configuration unit 134, evaluation unit 136, insight guidance unit 138, publication unit 140, personal assistant unit 142, and metadata generation unit 144 may be configured according to various implementation requirements. These components may improve user experience through implementation of self-service models. The self-service models may increase business subject matter expertise while decreasing required technical subject matter expertise. The self-service models may also allow a user to start or end anywhere within or across the fully integrated information landscape provided by computing system 120. The self-service models may show or hide assets where not implicated. The self-service models may review data flow based on physical and/or user-defined approved boundaries. The self-service models may further warn and/or be restricted in prevention of lineage gaps and orphaned assets. The self-service models may also subscribe to and/or publish content to fulfill data and augmentation requirements.

In general, aggregation unit 132 may create a collection of information assets 122. Configuration unit 134 may create an arrangement of information assets information assets 122. Evaluation unit 136 may validate all or a subset of information assets 122. Insight guidance unit 138 may generate recommendations and responses per user interaction and feedback with information assets 122. Publication unit 140 may maintain distribution and use presentation formats per security classification views of information assets 122.

Personal assistant unit 142 may enable data users in an organization to easily find answers to data related questions, rather than manually searching for data and contacts. Personal assistant unit 142 may connect data users with data (e.g., information assets 122) across internal and external sources and recommend best data sources for a particular need and people to contact.

Personal assistant unit 142 may be configured to perform artificial intelligence/machine learning (AI/ML), e.g., as a data artificial intelligence system (DAISY). Personal assistant unit 142 may provide a smart data assistant that uncovers where to find data and what data might be most helpful. Personal assistant unit 142 may provide a search and query-based solution to link ADMF data to searched business questions. Data SMEs may upload focused knowledge onto their domain into personal assistant unit 142 via a data guru tool to help inform auto-responses and capture knowledge. Personal assistant unit 142 may recommend data and data systems with a “best fit” to support business questions and provide additional datasets to a user for consideration.

Metadata generation unit 144 may generate element names, descriptions, and linkage to physical data elements for information assets 122. Business users may evaluate content generated using an AI/ML model, rather than manually generated. This may significantly reduce cycle times and increase efficiency, as the most human intensive part of the data management process is establishing the business context for data.

Metadata generation unit 144 may leverage AI/ML models to generate recommendations for one or more of business data element names, business data element descriptions, and/or linkages between business data elements and physical data elements. For example, a particular business context may describe a place where the business context is instantiated. If available, metadata generation unit 144 may leverage lineage data to derive business metadata based on technical and business metadata of the source, and combine the results to further refine generative AI/ML recommendations. Metadata generation unit 144 may receive suggestions from users to further train the AI/ML model. The suggestions may include accept or rejection suggestions, recommended updates, or the like. Metadata generation unit 144 may enhance the AI/ML model to learn from user-supplied fixes or corrections to term names and descriptions.

Aggregation unit 132 may create a collection of information assets 122. For example, aggregation unit 132 may create a data flow gallery. A user may request that a set of information assets from information assets 122 at point in a time data flow be aggregated into a data album. Aggregation unit 132 may construct the data album. Aggregation unit 132 may further construct a data flow gallery containing multiple such data albums, which are retrievable by configuration unit 134, evaluation unit 136, and publication unit 140.

Configuration unit 134 may create an arrangement of information assets 122. For example, configuration unit 134 may create an arrangement according to data distribution terms and conditions. A user may request to create or update a data distribution agreement. Configuration unit 134 may identify and arrange stock term and condition paragraphs, with optional embedded data fields in collaboration with aggregation unit 132, evaluation unit 136, and publication unit 140. Configuration unit 134 may support a variety of configuration types, such as functional configuration, temporal configuration, sequential configuration, or the like.

Evaluation unit 136 may validate all or a subset of information assets 122. For example, evaluation unit 136 may calculate a domain data flow health score. A user may request to evaluate new domain data flow health compliance completion metrics. Evaluation unit 136 may drill down into completion status and progress metrics, and provide recommendations to remediate issues and improve data health scores.

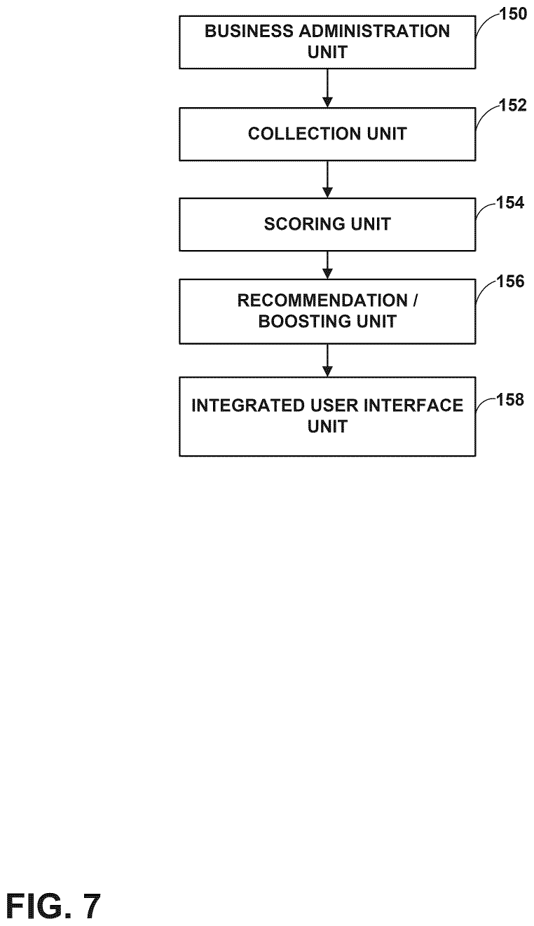

FIG. 7 is a flow diagram illustrating an example flow between elements of evaluation unit 136 that may be performed to calculate an overall health score for one or more of information assets 122 of FIG. 6. For example, evaluation unit 136 may calculate an overall health score for a particular metadata element, where the metadata element may represent one or more information assets of information assets 122. The overall health score may represent overall data quality as a combination of, e.g., quality analysis scores, data quality checks, defects, and user defined data scoring. Having a single overall health score to showcase the veracity and usability of the data represented by the metadata element may help users and systems to evaluate and recommend reuse of the most preferred assets of information assets 122. Additionally or alternatively, the overall health score may provide an objective valuation that may be used to communicate specific scenarios that may not be well supported by a particular data asset in comparison to other, similar data assets.

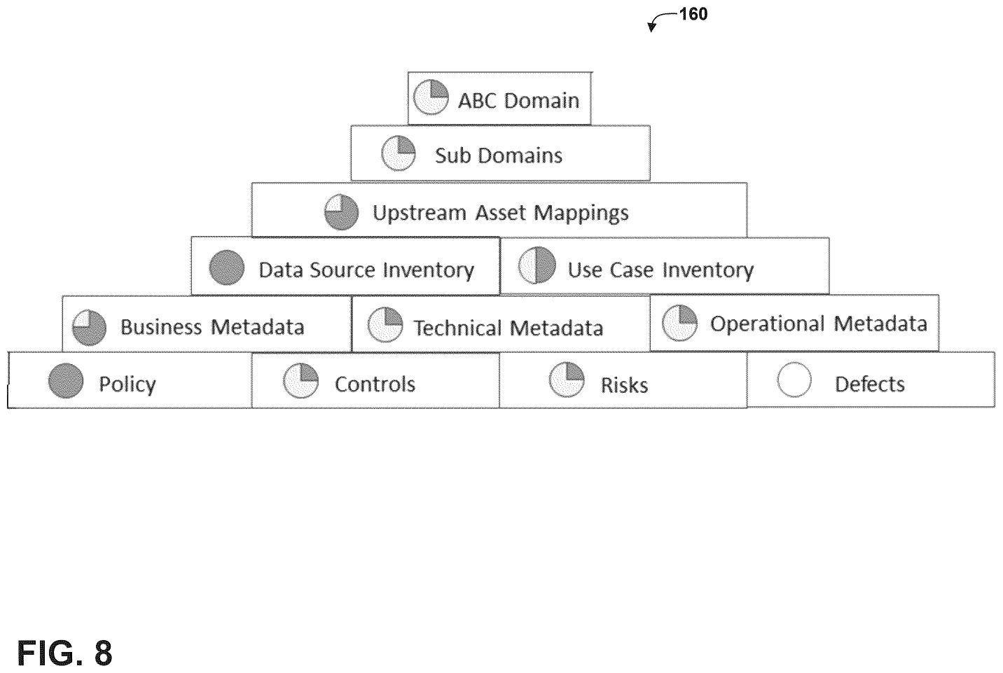

As discussed with respect to FIG. 8 below in greater detail, evaluation unit 136 may generate a visual representation of various information assets or progress status/metrics for performing various tasks related to interaction with information assets 122. Evaluation unit 136 may use the overall health scores associated with various metadata elements to visually showcase differentiation between similar data assets or data sources, e.g., based on defined rules, inputs, and/or algorithms. The overall health score may allow for central administration and case of updates to factors incorporated into the overall health score calculation algorithm, including the ability to extend, maintain, and/or deprecate the factors involved. Users and systems may review the overall health score to determine factors that contributed to the score. Users and systems may evaluate and determine which of the items that contributed to the overall health score are important for a given use case, to allow for selection of a best fit data asset for a particular context.

The factors used to calculate an overall health score may include data quality dimensions such as, for example, timeliness, completeness, consistency, or the like. Additionally or alternatively, the factors may include crowd-sourced sentiment regarding a corresponding data asset (e.g., one or more of information assets 122 represented by the metadata element for the overall health score). Additionally or alternatively, the factors may include information related to existing consumption of the data asset.

As an example, a user may have particular business need use case that could be met by one of four potential information assets. Evaluation unit 136 may calculate overall health scores for each of the four potential information assets. If one of the information assets has a particularly low overall health score, the user may immediately discount that information asset for the business need use case. The three remaining information assets may each have similar overall health scores. Thus, the user may review details supporting the techniques evaluation unit 136 used to calculate each of the overall health scores. Evaluation unit 136 may then present data to the user indicating that, for information asset A, the overall health score was impacted by a timeliness issue; information asset B is not supposed to be used for the business need use case; and the overall health score for information asset C is affected by a completeness issue. If the business need use case is for data on a monthly cadence, such that timeliness is not relevant because the data for the information asset will catch up in time to meet the business need, then the user may select information asset A.

In the example of FIG. 7, business administration unit may implement functionality used by business administrators to define and configure components (and weights to be applied to the components) that contribute to the overall health score (150). A collection unit may collect various information that contributes to the overall health score and may create the overall health score (152). A scoring unit may then create a score/value to communicate the overall health score via a user interface (154). A recommendation/boosting unit drives items with a similar applicability to a user's search to the top of a results set, which may be ordered by overall health scores and user preferences (156). An integrated user interface unit, which may present a textual and/or graphical user interface (GUI) via user interface 124 of FIG. 6, allows users to view the overall health score visual for available data assets communicated alongside search results in a data catalog or information marketplace view (158). The overall health score may use a single visualization to communicate high-level usability and preference for use. The integrated user interface unit may allow the user to drill into the overall health score (e.g., by way of a “double click” from a mouse pointer onto the overall health score) to view and evaluate the components that contribute to the value for applicability of the user's use case.

FIG. 8 is a conceptual diagram illustrating a graphical representation 160 of completion status and progress metrics that may be generated by evaluation unit 136 of FIG. 6. In this example, graphical representation 160 is hierarchically arranged such that higher nodes indicate aggregated statistics for hierarchically lower nodes. Each of the nodes in this example represents a particular task and its corresponding completion status and project metric as a pie chart.

In the example of FIG. 8, graphical representation 160 is a hierarchical graphical diagram. In various examples, evaluation unit 136 may generate a graphical diagram, a heat map, a narrative, or other representation, or a hybrid of any combination of these representations. Evaluation unit 136 may generate a graphical diagram that differentiates assets by, e.g., health score indicators. Evaluation unit 136 may generate a heat map that differentiates assets via successful, failed, or blocked indicators. Evaluation unit 136 may generate a narrative representation, such as online tables or grids. In some examples, evaluation unit 136 may download reporting formats and generate a graphical and/or narrative representation according to one of the reporting formats. Evaluation unit 136 may provide data representing which metrics were built leveraging the overall health score. In some examples, evaluation unit 136 may provide data indicating that a particular set of scenarios should not be used when constructing or evaluating a particular overall health score.

Evaluation unit 136 of FIG. 6 may provide data for one or more user interface views, presented via user interface 124, which may represent outcome, a multi-dimensional summary, and/or details associated with calculation of a domain data flow health score. Evaluation unit 136 may also indicate whether an evaluation was successful (i.e., whether the evaluation results meet applicable thresholds), failed (i.e., whether evaluation results did not meet the applicable thresholds), or blocked (e.g., if the status cannot be evaluated due to incompletion).

Insight guidance unit 138 may generate recommendations and responses per user interactions and feedback of information assets 122. For example, insight guidance unit 138 may generate a best fit data flow diagram. A user may request to view a data from a starting data source X to a use case Y. Insight guidance unit 138 may generate the data flow diagram based on the data flow scope, user approved boundaries, complexity, asset volume, and augmented information. Likewise, insight guidance unit 138 may generate the data flow diagram in collaboration with aggregation unit 132, configuration unit 134, evaluation unit 136, and publication unit 140. Insight guidance unit 138 may recommend a best fit diagram according to this collaboration.

Publication unit 140 may maintain distribution and use presentation formats per security classification views of information assets 122. For example, publication unit 140 may provide data allowing a user to review a data source compliance plan. The user may request to review compliance completion progress in graphical, narrative, vocal, or hybrid formats. Thus, publication unit 140 may receive data representing a requested format from the user and publish a report representing compliance completion progress in the requested format. The report may provide a summary level as well as various detailed dimensions, such that a user may review the summary level or drill down into different detailed dimensions to follow up with accountable parties associated with pending to completed workflow tasks.

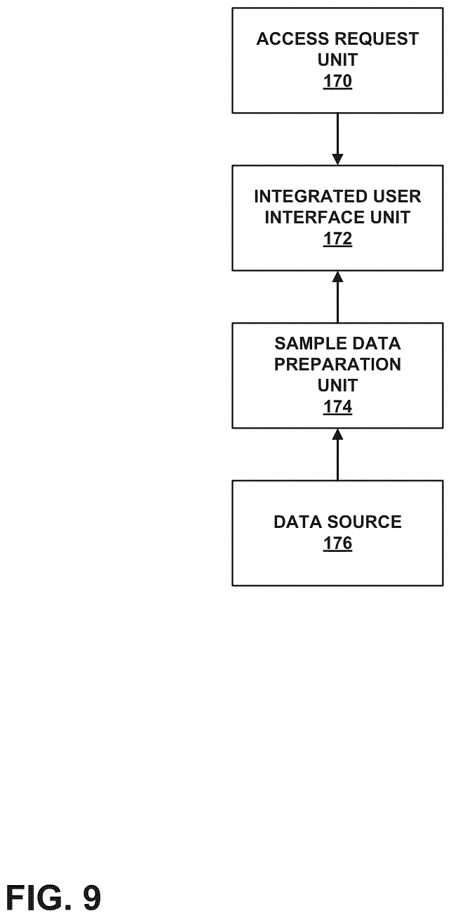

FIG. 9 is a block diagram illustrating an example automated data management framework (ADMF) according to techniques of this disclosure. In this example, the ADMF includes access request unit 170, integrated user interface unit 172, sample data preparation unit 174, and data source 176. Data source 176 may correspond to UDC 16 of FIGS. 1-4 or information assets 122 of FIG. 6. Integrated user interface unit 172 may correspond to the integrated user interface unit of FIG. 7 and may be presented via user interface 124 of FIG. 6. Integrated user interface unit 172 may form part of or be executed by processing system 130 of FIG. 6.

This disclosure recognizes that a large pain point in the experience of business data professionals is the frequent need to know who to ask about a particular problem and how to present the problem to that person. In particular, business data professionals may wish to determine specific accesses to requests and how to successfully submit such requests for data to be used to solve their business problems.

Sample data is often needed to definitively confirm that a specific set of data is going to help solve a business problem. Metadata is sometimes not sufficient to confirm that access to the described data will help to solve the business problem. Effectively managed sample data of information assets (e.g., information assets 122) may allow users to decide to request access to the corresponding full set of information assets. Providing a systemic solution may reduce or eliminate guess work and significantly reduce the two-part risk of: 1) unnecessary/overexpansive data access for analytic users to the wrong data, and 2) key users with required knowledge of data leave an enterprise.

The ADMF according to the techniques of this disclosure may provide an e-commerce-style “shopping cart” experience when viewing information presented in a data catalog or information marketplace, to facilitate a seamless, integrated, and systemic access request process. The ADMF may ensure that relevant accesses required for information assets presented in a given search result can be selected to add to the user's “cart” from a search result/detailed result page. The ADMF may offer the ability to add or remove “items” (i.e., access requests) to/from the user's “cart,” as well as to check out (submit) or save for later for the32ccessses in the cart. This may allow a user to “shop” for access to the proper information assets for themselves and/or others (e.g., other members of the user's analytic team). The ADMF may present users with an option to view representative sample data for a data point, alongside the available metadata and other information about the data in an integrated view.

In the example of FIG. 9, access request unit 170 integrates an available authoritative access provisioning mechanism. Sample data preparation unit 174 establishes a service to address required compliance, regulatory, privacy, and other necessary protections and treatments when preparing representative sample data. Services may use techniques such as masking, obfuscation, anonymization, or the like to prepare sample data from actual data in preparation for display as representative sample data. Sample data preparation unit 174 may, on demand, communicate with data source 176 to pull a representative set of records and apply predefined treatments to the representative set of records to generate the sample data prior to supplying the sample data to integrated user interface unit 172.

Integrated user interface unit 172 may offer users the ability to request to view representative sample data when on a detailed results view in a data catalog or information marketplace capability. Integrated user interface unit 172 may also provide on-demand access to a contextually accurate “request access” function on integrated views and pages in a data catalog/information marketplace capability.

After a user has received one or more sets of sample data from sample data preparation unit 174 via integrated user interface unit 172, the user may determine whether one of the one or more sets of sample data represents data that the user needs to complete a data management or data processing task. After determining that at least one of the sets of sample data represents such needed data, the user may request access to the underlying data set of data source 176 via access request unit 170. That is, the user may submit a request to access the data via integrated user interface unit 172, which may direct the request to access the data to access request unit 170. Access request unit 170 may direct data representative of the request to appropriate data managers, e.g., administrators, who can review and approve the request if the user is to be granted access to the requested set of data of data source 176.

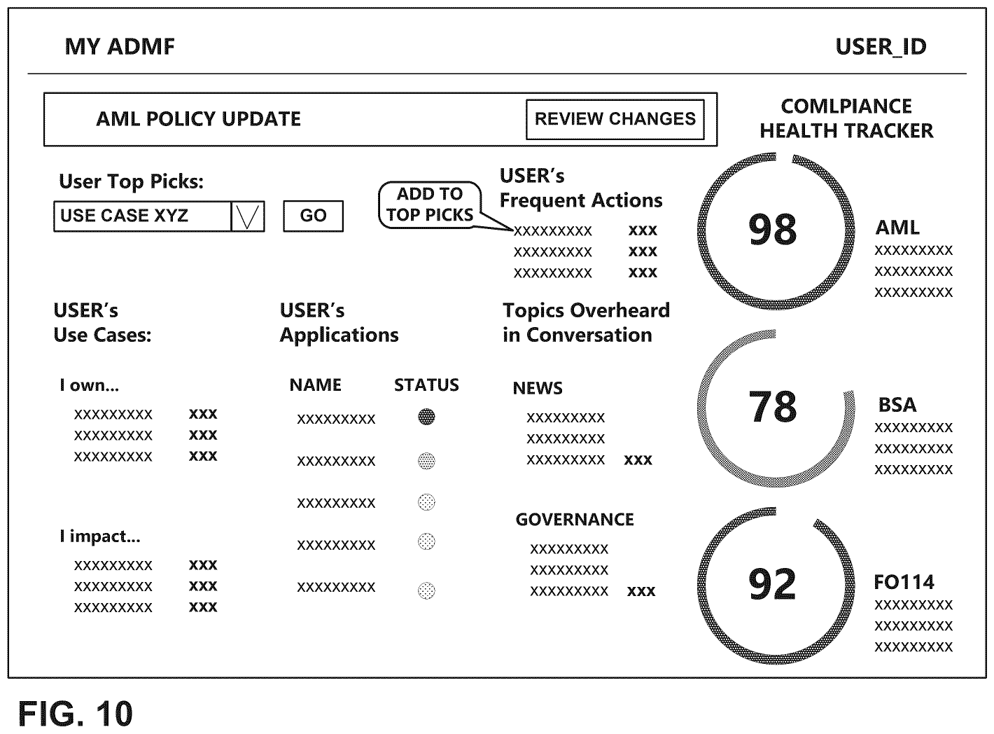

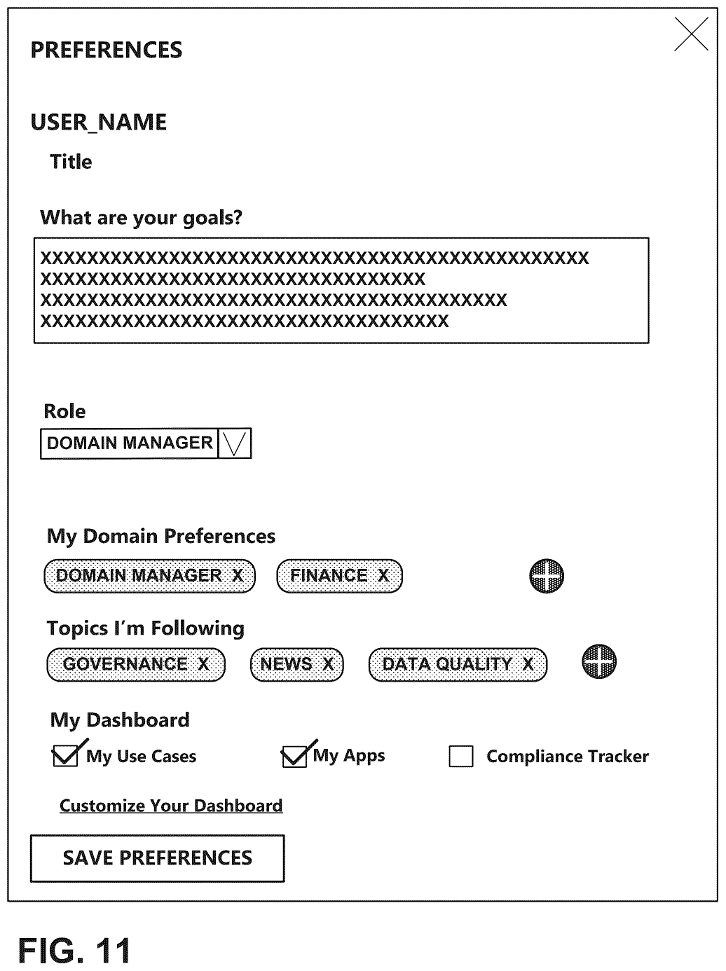

FIGS. 10 and 11 are example user interfaces that may be used to navigate a dashboard view presented to interact with information assets 122 of FIG. 6. The user interfaces may be presented by processing system 130 via user interface 124. FIG. 10 depicts an example dashboard user interface, while FIG. 11 depicts an example preferences menu that can be used to customize the dashboard user interface of FIG. 10. In general, the dashboard may help users easily find data of information assets 122 and navigate to areas of interest.

In general, the dashboard user interface of FIG. 10 may act as a homepage tailored to individual preferences (e.g., as set via the preferences menu of FIG. 11). The dashboard user interface may include information related to a user's organization and job function. The dashboard may be tailored and personalized by a user, e.g., via preferences set using the preferences menu of FIG. 11. The dashboard may aggregate details needed to track status and progress, and perform management tasks effectively. The dashboard may present data to a user quickly.

The dashboard user interface may include a variety of customizable widgets for various items within the data management framework. Each user can set personal preferences to customize the data to their work related needs. The widgets may act as a preview or summary of any area within the data management landscape. Thus, the user can use the widgets to navigate to a corresponding area of the data management landscape to take further action.

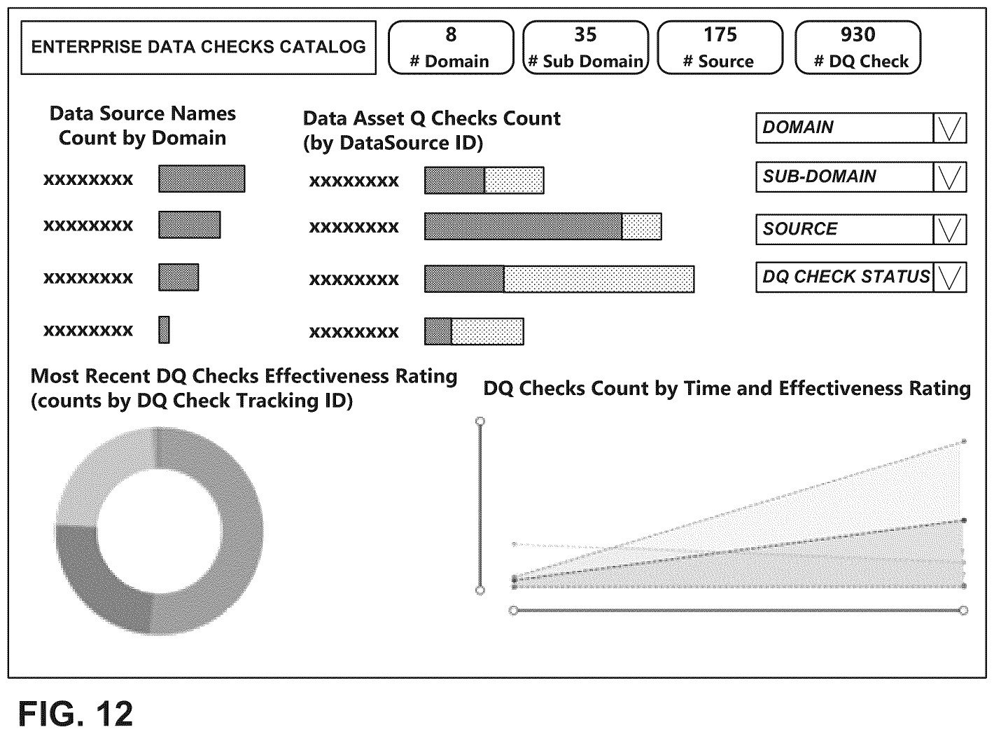

FIG. 12 is an example reporting user interface that may be used to present and receive interactions with curated reports on various devices, such as mobile devices. The devices may be separate from computing system 120 of FIG. 6. Computing system 120 may interact with the devices via network interface 126. Users may use the data presented via the reporting user interface to make decisions and to share in PC-prohibitive situations.

The reporting user interface may allow a user to open and view reports via website or application (app). The reporting user interface may receive user interactions with reports, e.g., requests to drill down into the reports and/or requests to expose report details. The reporting user interface may further provide the ability to share reports via mobile device integration, avoiding the need for email. The device (e.g., mobile device) presenting the report may further include a microphone for receiving audio commands and perform voice recognition or command shortcuts to allow users to access reports directly, without tactile navigation.

Graphical representations of data presented via the reporting user interface may include graphs, charts, and reports. Such representations may be structured such that the presentation is viewable on relatively smaller screened devices, such as mobile devices. This may enable users to perform decision making when only a mobile device is accessible. The user may create custom commands and voice shortcuts to access reports and data sets specific to the needs of the user. The device may dynamically modify the reporting user interface to multiple screen sizes without loss of detail or readability.

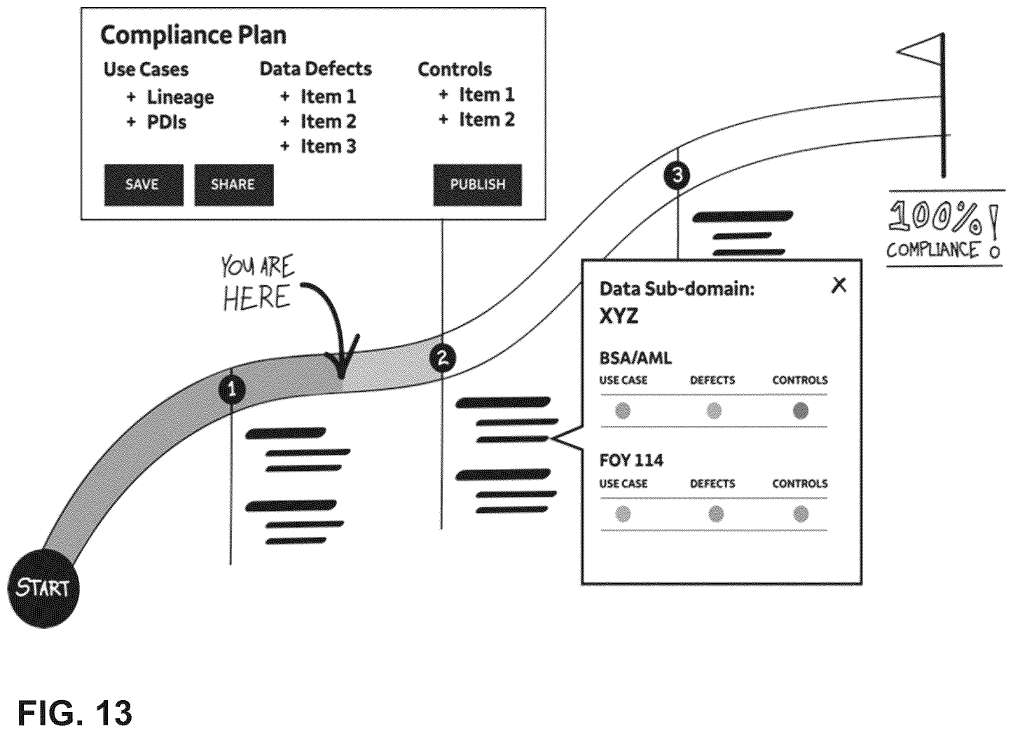

FIG. 13 is a conceptual diagram illustrating an example graphical depiction of a road to compliance report representing compliance with data management policies. The road to compliance report may help members of an organization automatically track, efficiently complete, and effectively report progress towards compliance with data management policies.

In general, the road to compliance report represents a holistic tracker that shows real time progress towards compliance at varying hierarchical levels, depending on the user's role and perspective. Computing system 120 may present the road to compliance report of FIG. 13 via user interface 124 and/or on remote devices (e.g., mobile devices) via network interface 126. Computing system 120 of FIG. 6 may generate stakeholder notifications with actions needed or recommendations to motivate members of the organization to take actions to drive progress toward compliance. The road to compliance report may provide the members of the organization with an overall data health score and recommendations for ways to raise the data health score as it relates to data management objectives within the organization.

As discussed above, evaluation unit 136 may calculate data health scores for various metadata elements. The metadata element may be associated with various use cases for corresponding data (e.g., information assets 122), defects within the corresponding data, and controls for the corresponding data. Evaluation unit 136 may thus calculate the data health scores. Insight guidance unit 138 may determine how to improve the scores and/or how to progress toward 100% compliance. Publication unit 140 may receive the data health scores from evaluation unit 136 and data representing how to improve the scores from insight guidance unit 138. Publication unit 140 may then generate and present the road to compliance report of FIG. 13 via user interface 124 and/or to remote devices via network interface 126.

The road to compliance report includes dynamically generated interactive, graphical reporting of tasks and/or steps needed for 100% compliance that have been completed, that are in progress, and/or are outstanding/to be performed. Computing system 120 may receive a request from a user to drill into any portion of the interactive road to compliance report to provide details such as actions needed to progress along the road to compliance and/or to alert users of critical items. The map view can be set at varying levels within the organization, so users can view relevant information for their role. For example, executives may be able to see the entire organization, whereas analysts may be able to see levels for which they are a member.

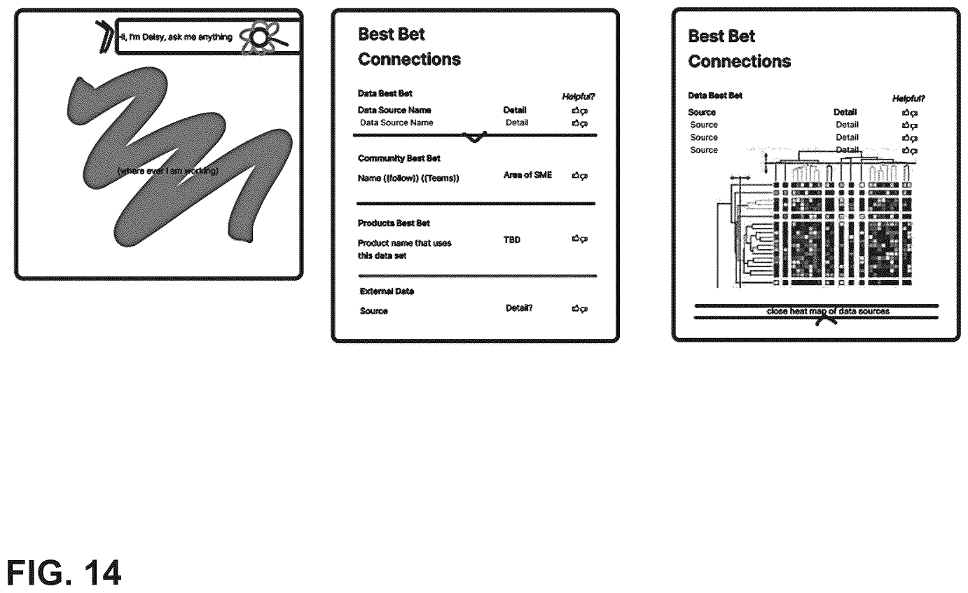

FIG. 14 is a conceptual diagram illustrating an example graphical user interface that may be presented by personal assistant unit 142 via user interface 124 of FIG. 6. In this example, personal assistant unit 142 uses an automated conversational artificial intelligence/machine learning (AI/ML) unit. In response to receiving a question from a user, personal assistant unit 142 may request follow up information from the user based on information and decisions accumulated in unified data catalog 16 (e.g., information assets 122).

Personal assistant unit 142 may also collect data entered by a user and store the collected data to further train the AI/ML model for future use and recommendations. Using the interfaces of FIG. 14, personal assistant unit 142 may present the integrated information to the user in response to the question from the user. Personal assistant unit 142 may present multiple configuration options to allow the user to request information in a manner best suited to the user's needs.

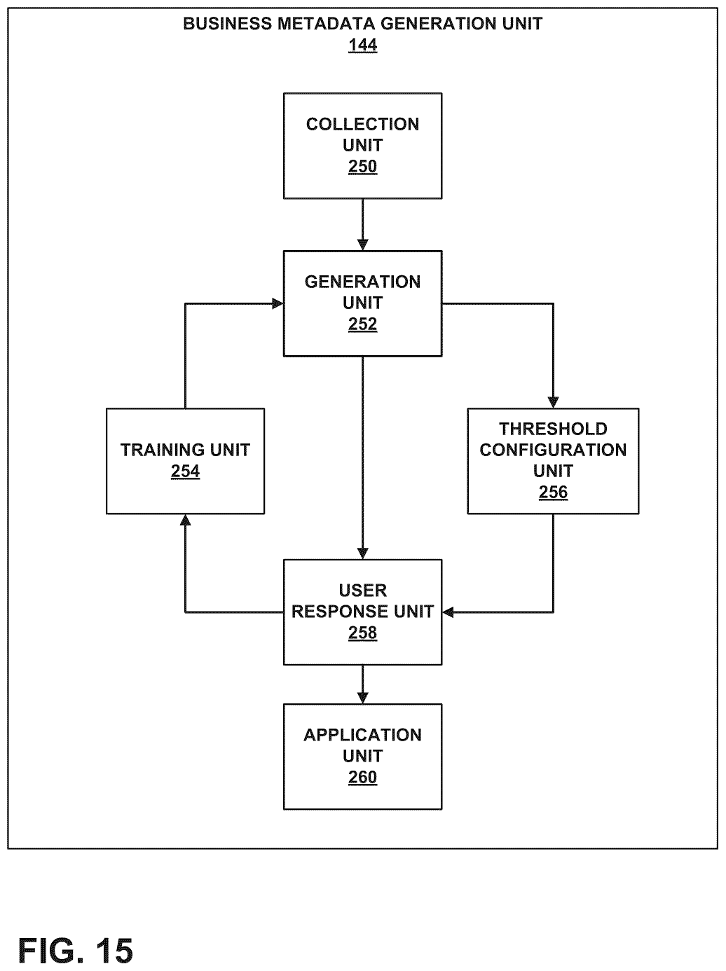

FIG. 15 is a block diagram illustrating an example set of components of business metadata generation unit 144 of FIG. 6. In this example, business metadata generation unit 144 includes collection unit 250, generation unit 252, threshold configuration unit 256, user response unit 258, training unit 254, user response unit 258, and application unit 258.

Collection unit 250 may be configured to collect available internally sourced/curated metadata, which may have been for a previously written business context. Collection unit 250 may also collect available lineage, provenance, profiling, and/or data flow information. Collection unit 250 may further collect available external metadata deemed to be relevant sources, such as Banking Industry Architecture Network (BIAN), Mortgage Industry Standards Maintenance Organization (MISMO), Financial Industry Business Ontology (FIBO), or the like.

Generation unit 252 may generate business metadata and context, as well as recommended linkage to technical metadata (e.g., descriptions for columns, tables, schemas, or the like).

Business metadata generation unit 144 may present generated metadata for review by a user via user response unit 258. User response unit 258 may also receive user input (e.g., via user interface 124 of FIG. 6), such as accept or rejection suggestions, recommended updates, or the like.

Business metadata generation unit 144 may then perform next actions in training unit 254 or application unit 260, based on the user responses received via user response unit 258 (e.g., accept, reject, discard, learn, train, etc.) or based on thresholds set by threshold configuration unit 256 to bypass user response.

Threshold configuration unit 256 may allow business administrators to configure options for setting thresholds as business metadata generation unit 144 generates recommendations to reduce or increase user interactions required to review those recommendations.

FIG. 16 is a block diagram illustrating an example data management system 300 according to techniques of this disclosure. In this example, data management system 300 includes data management and governance unit 310, application programming interface (API) 304, metadata registry 306, change event queue 308, unified data catalog 320, data catalogs 322A-322N, and data platforms 330. Data management and governance unit 310, metadata registry 306, API 304, and change event queue 308 may together correspond to metadata management unit 33 of FIG. 1; unified data catalog 320 and/or any or all of data catalogs 322 may correspond to unified data catalog 16 of FIG. 1; and data platforms 330 may correspond to data platforms 12 of FIG. 1.

User 302 may interact with data management and governance unit 310 using user interface 312, which may correspond to a command line interface (CLI), a graphical user interface (GUI), or the like. User interface 312 may also include hardware interface devices, such as a keyboard, mouse, pointer, touchscreen, monitor, or other input and/or output devices. Rather than interacting with data management system 300 directly via user interface 312, data management and governance unit 310 may provide an API that allows a user to interact remotely, e.g., via a web browser or application executed on a separate device that is communicatively coupled to data management and governance unit 310. Data management and governance unit 310 may provide any or all of a data inventory, technical metadata, business metadata, data lineage, a data catalog, or the like. A user may interact with user interface 312, and/or the API, to provide a query for metadata to data management system 300. For example, data management system 300 may receive a query over user interface 312 for metadata related to an information asset stored in one or more data catalogs 322 of data management system 300.

API 304 may include inbuilt services such as integration, active metadata management, an integration service, and/or a change management service. API 304 provides connections between data management and governance unit 310, metadata registry 306, change event queue 308, and data catalogues such as unified data catalog 320 and data catalogues 322.

Metadata registry 306 includes data representing locations or addresses of metadata for applications across an enterprise. That is, metadata registry 306 may store mapping data that maps information assets to locations of metadata related to the information assets (e.g., one or more data catalogs 322). Data management and governance unit 310 may construct metadata registry 306 via API 304 programmatically, or users (e.g., administrators) may manually construct metadata registry 306, based on a type of a corresponding data source. API 304 may interact with metadata registry 306 to determine an address of corresponding metadata, invoke appropriate procedures or API function calls to read and/or integrate metadata from underlying data catalogs (e.g., unified data catalog 320 and/or one of data catalogs 322) to fulfil a request from user 302. For example, in response to receiving a query for metadata from a user (e.g. using user interface 312), API 304 may interact with metadata registry 306 to determine the location of the queried metadata. API 304 may be configured to retrieve the metadata from the determined location and provide the metadata in response to the query (e.g., over user interface 312).

API 304 also provides functions for interacting with active metadata, that is, metadata that is required by the enterprise to fulfil data management and governance requirements. Active technical metadata may be identified implicitly based on usage, such as linkage in business metadata, data lineage, and/or data quality. Alternatively, user 302 may explicitly define active technical metadata. API 304 may further provide an integration service that integrates active metadata with other modules within unified data catalog 320 from across various sources (e.g., data platforms 330).

Data catalogs 322 may correspond to various data catalog solutions used to store a set of information assets. For example, data catalog 322A may represent an on premises data catalog, data catalog 322B may represent a public cloud data catalog, and data catalog 322N may represent a private cloud data catalog. Unified data catalog 320 and data catalogs 322 may be configured to publish metadata changes via change event queue 308, which directs messages indicating changes to metadata to API 304.

API 304 may further provide change management functions. A change management service may process incoming metadata change events from change event queue 308, and may update metadata registry 306 accordingly. API 304 may also send changed metadata notifications to business users, such as user 302, and/or to downstream consumers to take appropriate actions or make appropriate decisions. Also, the change management service may trigger user workflows, active metadata management, and/or integration services as appropriate.

API 304 may generally maintain metadata registry 306 in response to other changes in data catalog 320 and/or one of data catalogs 322. For example, API 304 may determine that an information asset of one of data catalogs 322 has been modified (e.g., an information asset has been changed, deleted from one of data catalogs 322, added to one of data catalogs 322, etc.). In response to determining a modification has taken place, API 304 may be configured to update metadata registry 306 in response.

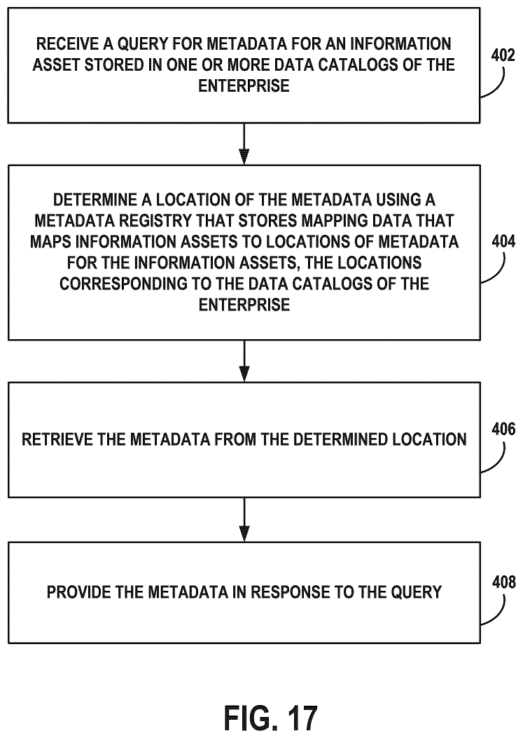

FIG. 17 is a flow diagram illustrating example operations of receiving and responding to a query for metadata for an information asset, according to techniques of this disclosure. FIG. 17 is described below within the context of data management system 300 of FIG. 16. In other examples, operations described in FIG. 17 may be performed by one or more other components, modules, systems, or devices. Further, in other examples, operations described in connection with FIG. 17 may be merged, performed in a different sequence, omitted, or may encompass additional operations not specifically illustrated or described.

In the process illustrated in FIG. 17, and in accordance with one or more aspects of the present disclosure, data management system 300 receives a query for metadata for an information asset stored in one or more data catalogs of the enterprise responsible for managing data management system 300 (402). In some examples, data management system 300 may receive the query from a user via a user interface, such as user interface 312. In other examples, data management system 300 may receive the query via an application programming interface.

Data management system 300 determines a location of the queried metadata using metadata registry 306, configured to store mapping data that maps information assets to locations of metadata for the information assets, the locations corresponding to the data catalogs of the enterprise (404). Upon determining the location, data management system 300 retrieves the metadata from the determined location (406) and provides the metadata (e.g., to the user and/or requesting system) in response to the query (408). In some examples, data management system 300 may be further configured to receive a change event message from unified data catalog 320 or one of data catalogs 322 via change event queue 308. Data management system 300 may update metadata registry 306 according to the change event message. In other examples, data management system 300 may update metadata registry 306 in response to determining that an information asset of unified data catalog 320 or one of the data catalogs 322 has been modified (e.g., deleted, added to the data catalog, changed, etc.).

The following clauses represent various examples of the techniques of this disclosure:

Clause 1: A computing system comprising: a memory storing a plurality of information assets; and a processing system of an enterprise, the processing system comprising one or more processors implemented in circuitry, the processing system being configured to: receive a query for metadata for an information asset stored in one or more data catalogs of the enterprise; determine a location of the metadata using a metadata registry that stores mapping data that maps information assets to locations of metadata for the information assets, the locations corresponding to the data catalogs of the enterprise; retrieving the metadata from the determined location; and providing the metadata in response to the query.

Clause 2: The computing system of clause 1, wherein the processing system is further configured to: receive a change event message from one of the data catalogs via a change event queue; and update the metadata registry according to the change event message.

Clause 3: The computing system of any of clauses 1 and 2, wherein to receive the query, the processing system is configured to receive the query from a user via a user interface.

Clause 4: The computing system of any of clauses 1 and 2, wherein to receive the query, the processing system is configured to receive the query via an application programming interface.

Clause 5: A computing system comprising: a memory storing a plurality of information assets; and a processing system of an enterprise, the processing system comprising one or more processors implemented in circuitry, the processing system being configured to: maintain a metadata registry that stores mapping data that maps information assets to locations of metadata for the information assets, the locations corresponding to a plurality of data catalogs of the enterprise, each of the data catalogs storing a respective subset of the information assets; determine that an information asset of one of the data catalogs has been modified; and update the metadata registry in response to the modification.

Clause 6: A computing system comprising a combination of the computing system of any of clauses 1-4 and the computing system of clause 5.

Clause 7: The computing system of any of clauses 5 and 6, wherein at least one of the data catalogs comprises a unified data catalog.

Clause 8: The computing system of any of clauses 5-7, wherein the modification comprises one of an addition, a change, or a deletion.

Clause 9: The computing system of any of clauses 1-8, wherein the metadata includes one or more of a location of a corresponding information asset, business metadata for the corresponding information asset, a lineage of data for the corresponding information asset, where the corresponding information asset has been used, or a data quality score for the corresponding information asset.

Clause 10: A method performed by the computing system of any of clauses 1-9.

Clause 11: A computer-readable storage medium having stored thereon instructions that, when executed, cause one or more processors to perform the method of clause 10.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For case of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of computer programs from one place to another, e.g., according to a communication protocol. In this manner, computer-readable storage media generally may correspond to (1) tangible computer-readable storage media which is non-transitory or (2) a communication media such as signal or carrier wave. Data storage media may be any available media that may be accessed by one or more computers or one or more processing circuits to receive instructs, code and/or data structures for implementation of the techniques described in this disclosure. A computer program product may include a computer-readable medium.

By way of example and not limitation, such computer-readable storage media may include RAM, ROM, EEPROM, CD-ROM, or other optical disk storage, magnetic disk storage, or other magnetic storage devices, flash memory, cache memory, or any other medium that may be used to store desired program code in the form of instructions or store data structures and that may be access by a computer. Also, any connection is a properly termed a computer-readable medium. For example, if instructions are transmitted from a website, server, or other remote source using a coaxial cable, fiber optic cable, twisted pair, digital subscriber line (DSL), or other wireless technologies such as infrared, radio, and microwave, then the coaxial cable, fiber optic cable, twisted pair, DSL, or other wireless technologies such as infrared, radio, and microwave are included in the definition of medium. It should be understood, however, that computer readable storage media and data storage media do not include connections, carrier waves, signals, or other transient media, but are directed to non-transient, tangible storage media. Disk and disc, as used herein, includes compact disk (CD), laser disc, optical disc, digital versatile disc (DVD), and Blu-ray disc, where disks usually reproduce data magnetically, while discs reproduce data optically with lasers. Combinations of the above should be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor”, as used herein may refer to any of the foregoing structure of any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, software systems, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A computing system comprising:
a memory storing a plurality of information assets; and
a processing system of an enterprise, the processing system comprising one or more processors implemented in circuitry, the processing system being configured to:
receive a query for metadata for an information asset stored in one or more data catalogs of the enterprise;
determine a location of the metadata using a metadata registry that stores mapping data that maps information assets to locations of metadata for the information assets, the locations corresponding to the data catalogs of the enterprise;
retrieve the metadata from the determined location; and
provide the metadata in response to the query.

2. The computing system of claim 1, wherein the processing system is further configured to:
receive a change event message from one of the data catalogs via a change event queue; and
update the metadata registry according to the change event message.

3. The computing system of claim 1, wherein to receive the query, the processing system is configured to receive the query from a user via a user interface (UI).

4. The computing system of claim 1, wherein to receive the query, the processing system is configured to receive the query via an application programming interface (API).

5. The computing system of claim 1, wherein the metadata includes one or more of a location of a corresponding information asset, business metadata for the corresponding information asset, a lineage of data for the corresponding information asset, where the corresponding information asset has been used, or a data quality score for the corresponding information asset.

6. The computing system of claim 1, wherein the processing system is further configured to:
maintain the metadata registry, wherein each of the data catalogs stores a respective subset of the information assets;
determine that an information asset of one of the data catalogs has been modified; and
update the metadata registry in response to the modification.

7. The computing system of claim 6, wherein at least one of the data catalogs comprises a unified data catalog.

8. The computing system of claim 6, wherein the modification comprises one of an addition, a change, or a deletion.

9. The computing system of claim 1, wherein the metadata is related to one or more Data Management & Governance requirements for the enterprise.

10. A computer-implemented method comprising:
receiving, by one or more processors, a query for metadata for an information asset stored in one or more data catalogs of the enterprise;
determining, by the one or more processors, a location of the metadata using a metadata registry that stores mapping data that maps information assets to locations of metadata for the information assets, the locations corresponding to the data catalogs of the enterprise;
retrieving, by the one or more processors, the metadata from the determined location; and
providing, by the one or more processors, the metadata in response to the query.

11. The method of claim 10, further comprising:
receiving, by the one or more processors, a change event message from one of the data catalogs via a change event queue; and
updating, by the one or more processors, the metadata registry according to the change event message.

12. The method of claim 10, wherein receiving the query comprises receiving, by the one or more processors and from a user, the query via a user interface (UI).

13. The method of claim 10, wherein receiving the query comprises receiving, by the one or more processors, the query via an application programming interface (API).

14. The method of claim 10, wherein the metadata includes one or more of a location of a corresponding information asset, business metadata for the corresponding information asset, a lineage of data for the corresponding information asset, where the corresponding information asset has been used, or a data quality score for the corresponding information asset.

15. The method of claim 10, further comprising:
maintaining, by the one or more processors, the metadata registry, wherein each of the data catalogs stores a respective subset of the information assets;
determining, by the one or more processors, that an information asset of one of the data catalogs has been modified; and
updating, by the one or more processors, the metadata registry in response to the modification.

16. The method of claim 15, wherein at least one of the data catalogs comprises a unified data catalog.

17. The method of claim 15, wherein the modification comprises one of an addition, a change, or a deletion.

18. Non-transitory computer-readable storage media having stored thereon instructions that, when executed, cause one or more processors to:
receive a query for metadata for an information asset stored in one or more data catalogs of the enterprise;
determine a location of the metadata using a metadata registry that stores mapping data that maps information assets to locations of metadata for the information assets, the locations corresponding to the data catalogs of the enterprise;
retrieve the metadata from the determined location; and
provide the metadata in response to the query.

19. The non-transitory computer-readable storage media of claim 18, further comprising instructions that cause the one or more processors to:
receive a change event message from one of the data catalogs via a change event queue; and
update the metadata registry according to the change event message.

20. The non-transitory computer-readable storage media of claim 18, further comprising instructions that cause the one or more processors to:
maintain the metadata registry, wherein each of the data catalogs stores a respective subset of the information assets;
determine that an information asset of one of the data catalogs has been modified; and
update the metadata registry in response to the modification.
